(19) United States
(12) Patent Application Publication
(10) Pub. No.: US 2025/0299853 A1
(43) Pub. Date: Sep. 25, 2025

(54) HOT DEFORMED MAGNET

(71) Applicant: TDK Corporation, Tokyo (JP)

(72) Inventors: Lihua LIU, Tokyo (JP); Mutsuki SAITO, Tokyo (JP)

(73) Assignee: TDK Corporation, Tokyo (JP)

(21) Appl. No.: 19/075,966

(22) Filed: Mar. 11, 2025

(30) Foreign Application Priority Data
Mar. 22, 2024 (JP) 2024-047245
Jan. 7, 2025 (JP) 2025-002399

(51) Int. Cl. H01F 1/057; C22C 38/00; H01F 41/02

(52) U.S. Cl. CPC H01F 1/0576; C22C 38/002; C22C 38/005; H01F 41/0293

(57) ABSTRACT

A hot deformed magnet contains a rare-earth element R, a transition metal element T, and boron. The hot deformed magnet contains Nd as the rare-earth element R. The hot deformed magnet contains Fe as the transition metal element T. The hot deformed magnet contains a plurality of main phase grains and a grain boundary phase positioned between the plurality of main phase grains. The plurality of main phase grains contain the rare-earth element R, the transition metal element T, and boron. The grain boundary phase contains a plurality of crystal grains. The plurality of crystal grains are in contact with the one or more main phase grains. Crystal zone axes of the plurality of crystal grains are oriented along a single direction.

### CROSS-REFERENCE TO RELATED APPLICATIONS

This application is based upon and claims the benefit of priority from Japanese Patent Application No. 2025-002399, filed on Jan. 7, 2025, and Japanese Patent Application No. 2024-047245, filed on Mar. 22, 2024, the entire contents of which are incorporated herein by reference.

### BACKGROUND

### Field

The present disclosure relates to a hot deformed magnet.

### Description of the Related Art

In recent years, with spread of wind power generation and electric vehicles, a demand of a neodymium magnet has increased, and improvement in its characteristics has been required. In order to discover a formation mechanism of a coercivity that is important characteristics of the neodymium magnet, many researches and developments have been accumulated in recent years, and understanding of the formation mechanism of the coercivity has been deepened. (for example, refer to Patent Literature 1 and Non Patent Literature1.) The coercivity of the neodymium magnet is theoretically determined based on a crystal anisotropy field Ha of a ferromagnetic material (for example, Nd₂Fe₁₄B) configuring the neodymium magnet.

However, since an actual neodymium magnet contains polycrystals, only a coercivity of about 20% of a theoretical value can be exhibited.
Patent Literature 1: Japanese Unexamined Patent Publication No. 2019-009421
Non Patent Literature1: H. Sepehri-Amin et al., Grainboundary and interface chemistry of an Nd—Fe—B-based sintered magnet, ActaMaterialia 60 (2012) 819-830, Published by Elsevier Ltd.

### SUMMARY

An object of one aspect of the present disclosure is to provide a hot deformed magnet having a high coercivity.

For example, as described below, one aspect of the present disclosure relates to a hot deformed magnet described in any one of [1] to [14].

[1]A hot deformed magnet including a rare-earth element R, a transition metal element T, and boron, in which
the hot deformed magnet contains Nd, as the rare-earth element R,
the hot deformed magnet contains Fe, as the transition metal element T,
the hot deformed magnet contains a plurality of main phase grains and a grain boundary phase positioned between the plurality of main phase grains,
the plurality of main phase grains contain the rare-earth element R, the transition metal element T, and the boron,
the grain boundary phase contains a plurality of crystal grains,
the plurality of crystal grains are in contact with the one or more main phase grains, and
crystal zone axes of the plurality of crystal grains are oriented along a single direction.

[2] The hot deformed magnet according to [1], in which the plurality of crystal grains are non-magnetic.

[3] The hot deformed magnet according to [1] or [2], in which
an area fraction of cross sections of the plurality of crystal grains in a cross section of the hot deformed magnet is from 3% to 8%, and
the cross section of the hot deformed magnet is parallel to an easy magnetization axis direction of the hot deformed magnet.

[4] The hot deformed magnet according to any one of [1] to [3], in which
the plurality of crystal grains contain the rare-earth element R and an element M,
the element M is at least one selected from the group consisting of Cu, Ga, Zn, Ni, and Cr,
a content of the rare-earth element R in the plurality of crystal grains is from 50 mass % to 98 mass %,
a content of the transition metal element T in the plurality of crystal grains is from 0 mass % to 50 mass %, and
a content of the element M in the plurality of crystal grains is more than 0 mass % and is 35 mass % or less.

[5] The hot deformed magnet according to any one of [1] to [4], in which
each of the plurality of crystal grains is a cubic crystal, a tetragonal crystal, or an orthorhombic crystal, and
the crystal zone axes are <100>, <010>, or <001>.

[6] The hot deformed magnet according to any one of [1] to [4], in which
the plurality of crystal grains contain Nd and Cu,
each of the plurality of crystal grains is a cubic crystal, a tetragonal crystal, or an orthorhombic crystal, and
a space group indicating symmetry of a crystal structure of each of the plurality of crystal grains is Pnma, I4/mcm, Fm-3m, or Ia-3.

[7] The hot deformed magnet according to any one of [1] to [6], in which
a width of the grain boundary phase containing the one or more crystal grains is from 4 nm to 500 nm in the easy magnetization axis direction of the hot deformed magnet.

[8] The hot deformed magnet according to any one of [1] to [7], in which
the one or more main phase grains in contact with the one or more crystal grains contain at least one of a columnar crystal and an equiaxed crystal.

[9] The hot deformed magnet according to any one of [1] to [8], further including an element M, in which
the element M is at least one selected from the group consisting of Cu, Ga, Zn, Ni, and Cr,
a content of the rare-earth element R in the hot deformed magnet is from 26.00 mass % to 32.00 mass %,
a content of the boron in the hot deformed magnet is from 0.77 mass % to 1.15 mass %, and
a content of the element M in the hot deformed magnet is from 0.67 mass % to 7.30 mass %.

[10] The hot deformed magnet according to any one of [1] to [9], in which
a width of each of the plurality of main phase grains in the easy magnetization axis direction of the hot deformed magnet is represented as S,
a width of each of the plurality of main phase grains in a direction perpendicular to the easy magnetization axis direction is represented as L,
the S is smaller than the L,
L/S is from 2 to 10, and
the S is from 20 nm to 200 nm.

[11] The hot deformed magnet according to any one of [1] to [10], in which
an angle between <100> of the plurality of crystal grains and <100> of the one or more main phase grains is from 0° to 10°.

[12] The hot deformed magnet according to any one of [1] to [10], in which
an angle between <010> of the plurality of crystal grains and <010> of the one or more main phase grains is from 0° to 10°.

[13] The hot deformed magnet according to any one of [1] to [10], in which
an angle between <001> of the plurality of crystal grains and <001> of the one or more main phase grains is from 0° to 10°.

[14] The hot deformed magnet according to any one of [1] to [13], in which
the single direction in which the crystal zone axes of the plurality of crystal grains are oriented is parallel to crystal zone axes of the one or more main phase grains in contact with the plurality of crystal grains.

According to one aspect of the present disclosure, a hot deformed magnet having a high coercivity is provided.

### BRIEF DESCRIPTION OF THE DRAWINGS

FIG. 1A is a schematic perspective view of a hot deformed magnet, FIG. 1B is a schematic view of a cross section of the hot deformed magnet in FIG. 1A (an arrow view along a line I-I direction in hot deformed magnet), and the cross section shown in FIG. 1B is parallel to an easy magnetization axis direction of the hot deformed magnet;

FIG. 2 is an enlarged view of a part (region II) of the cross section shown in FIG. 1B;

FIG. 3A is a schematic view of a cross section of one secondary grain containing a polycrystal among a plurality of main phase grains contained in the hot deformed magnet, and FIG. 3B is an enlarged view of a part (region III) of the cross section shown in FIG. 3A;

FIG. 4 is a schematic view illustrating a unit cell and a crystal zone axis of each of a pair of crystal grains contained in the hot deformed magnet;

FIG. 5 is a schematic perspective view of a specific example of a mold used in a method (hot deforming step) for manufacturing the hot deformed magnet;

FIG. 6 is a backscattered electron image of a cross section of the hot deformed magnet of Example 1, and the cross section shown in FIG. 6 is parallel to an easy magnetization axis direction of the hot deformed magnet;

FIG. 7A is a backscattered electron image of the cross section of the hot deformed magnet of Example 1, the cross section shown in FIG. 7A is parallel to the easy magnetization axis direction of the hot deformed magnet, FIG. 7B is a backscattered electron image of the cross section of the hot deformed magnet of Example 1, the cross section shown in FIG. 7B is parallel to the easy magnetization axis direction of the hot deformed magnet, and the cross section shown in each of FIG. 7A and FIG. 7B is a backscattered electron image taken at a higher magnification than the backscattered electron image shown in FIG. 6;

FIG. 8 is a transmission electron microscope image (TEM image) of the cross section of the hot deformed magnet of Example 1, and the cross section shown in FIG. 8 is parallel to the easy magnetization axis direction of the hot deformed magnet;

FIG. 9A is an electron beam diffraction pattern measured by directing an incident electron beam into a measurement point 1 (crystal grain) in the cross section shown in FIG. 8, FIG. 9B is an electron beam diffraction pattern measured by directing an incident electron beam into a measurement point 2 (crystal grain) in the cross section shown in FIG. 8, FIG. 9C is an electron beam diffraction pattern measured by directing an incident electron beam into a measurement point 3 (crystal grain) in the cross section shown in FIG. 8, and FIG. 9D is an electron beam diffraction pattern measured by directing an incident electron beam into a measurement point 7 (crystal grain) in the cross section shown in FIG. 8;

FIG. 10A is an electron beam diffraction pattern measured by directing an incident electron beam into a measurement point 4 (NdO) in the cross section shown in FIG. 8, FIG. 10B is an electron beam diffraction pattern measured by directing an incident electron beam into a measurement point 5 (main phase grain) in the cross section shown in FIG. 8, and FIG. 10C is an electron beam diffraction pattern measured by directing an incident electron beam into a measurement point 6 (main phase grain) in the cross section shown in FIG. 8; and

FIG. 11 is a schematic view illustrating a cross section of each of a plurality of crystal grains and a plurality of main phase grains contained in the hot deformed magnet, and each cross section shown in FIG. 11 is parallel to the easy magnetization axis direction of the hot deformed magnet.

### DETAILED DESCRIPTION

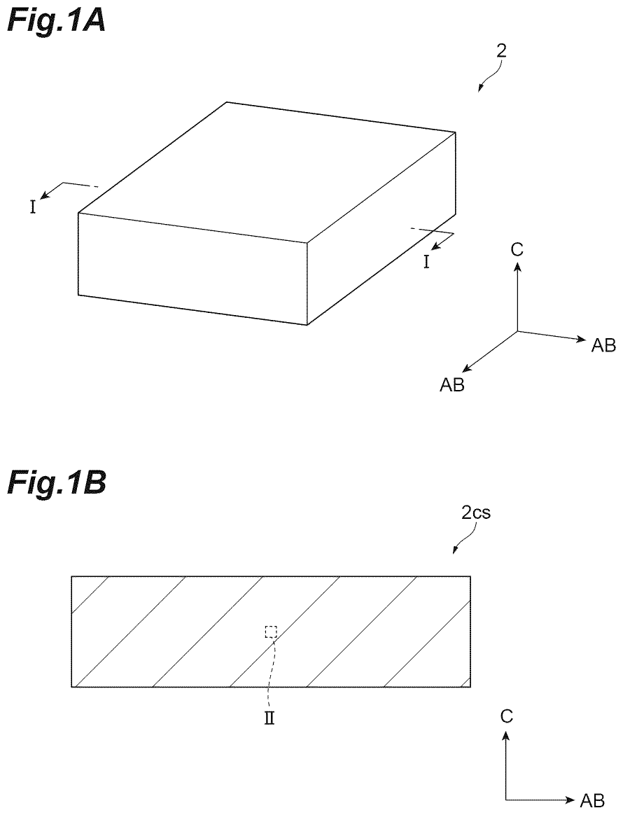

In the following description, with reference to the drawings, the same reference numbers are assigned to the same components or to similar components having the same function, and overlapping description is omitted. The present disclosure is not limited to the embodiment. One arrow C and two arrows AB shown in FIG. 1A indicate three coordinate axes orthogonal to each other. The arrow C corresponds to an easy magnetization axis direction C of a hot deformed magnet. Each of the two arrows AB corresponds to an AB direction orthogonal to the easy magnetization axis direction C. Each of the easy magnetization axis direction C and the AB direction is common to the drawings.

### (Hot Deformed Magnet)

The hot deformed magnet according to the present embodiment contains at least a rare-earth element R, a transition metal element T, and boron (B).

The hot deformed magnet contains at least neodymium (ND), as the rare-earth element R. The hot deformed magnet may further contain other rare-earth elements R, in addition to Nd. The other rare-earth elements R contained in the hot deformed magnet may be at least one element selected from the group consisting of scandium (Sc), yttrium (Y), lanthanum (La), cerium (Ce), praseodymium (Pr), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The hot deformed magnet does not need to contain a heavy rare-earth element (for example, both of Dy and Tb).

The hot deformed magnet contains at least iron (Fe), as the transition metal element T. The hot deformed magnet may contain only Fe, as the transition metal element T. The hot deformed magnet may contain both of Fe and cobalt (Co), as the transition metal element T.

FIG. 1A is a perspective view of a hot deformed magnet 2. FIG. 1B is a schematic view of a cross section 2cs of the hot deformed magnet 2. The cross section 2cs of the hot deformed magnet 2 is substantially or completely parallel to the easy magnetization axis direction C of the hot deformed magnet 2. The easy magnetization axis direction C is a direction parallel to a straight line connecting a pair of magnetic poles of the hot deformed magnet 2. That is, the easy magnetization axis direction C is a direction from the S pole of the hot deformed magnet 2 to the N pole of the hot deformed magnet 2. The easy magnetization axis direction C may be specified based on measurement of a magnetic flux distribution of the hot deformed magnet 2. The easy magnetization axis direction C may be specified based on measurement of a magnetic flux distribution of an analysis sample separated from the hot deformed magnet 2. As described above, the AB direction is perpendicular to the easy magnetization axis direction C.

The hot deformed magnet 2 shown in FIG. 1A is a rectangular parallelepiped (plate). However, a shape of the hot deformed magnet 2 is not limited to the rectangular parallelepiped. For example, the shape of the hot deformed magnet 2 may be a cube, a polygonal column, an arc segment, an annular sector, a sphere, a disk, a cylinder, a tube, or a ring. For example, a shape of the cross section 2cs of the hot deformed magnet 2 may be a polygon, an arc (circular chord), a circular segment, an arch, a C-shape, or a circle.

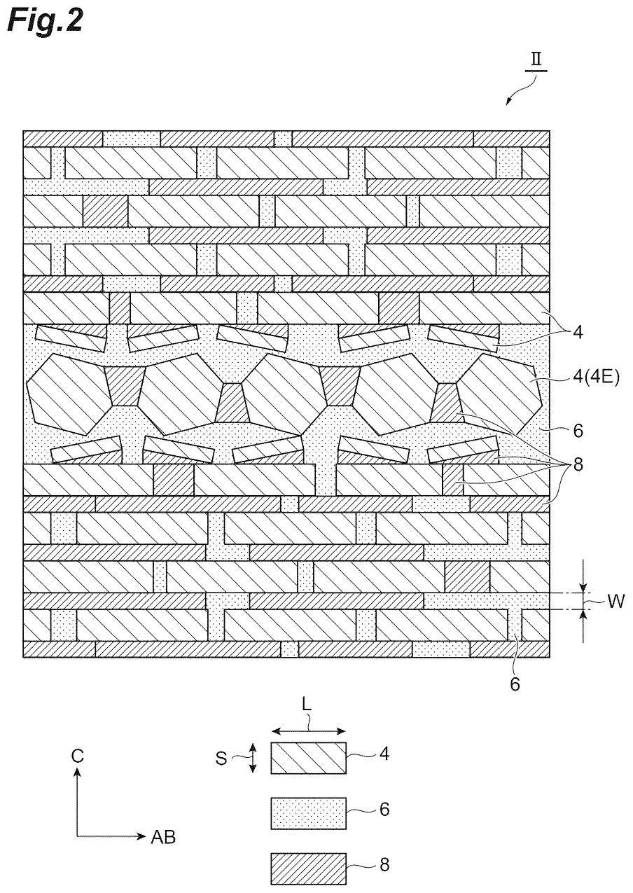

FIG. 2 is an enlarged view of a part (region II) of the cross section 2cs shown in FIG. 1B. As shown in FIG. 2, the hot deformed magnet 2 contains a plurality of main phase grains 4 and a grain boundary phase 6 positioned between the plurality of main phase grains 4. In the present disclosure, the grain boundary phase 6 is a generic term indicating all components other than the plurality of main phase grains 4 (that is, remaining components, other than all main phase grains 4, of hot deformed magnet 2). The hot deformed magnet 2 may contain the plurality of grain boundary phases 6 different in position.

For example, the grain boundary phase 6 may exist in a grain boundary (grain boundary multiple junction) surrounded by three or more main phase grains 4. For example, the grain boundary phase 6 may exist in a grain boundary (two-grain boundary) between the two main phase grains 4.

The plurality of main phase grains 4 contain at least the rare-earth element R, the transition metal element T, and B. The main phase grain 4 contains at least Nd, as the rare-earth element R. The main phase grain 4 contains at least Fe, as the transition metal element T. One main phase grain 4 may be one crystal grain (that is, primary grain). At least a part or all of the plurality of main phase grains 4 contained in the hot deformed magnet 2 may be secondary grains containing polycrystals (plurality of primary grains). The hot deformed magnet 2 may contain the plurality of secondary grains. One secondary grain may contain the plurality of main phase grains 4. The main phase grain 4 contains a crystal (single crystal or polycrystal) of R₂T₁₄B. R₂T₁₄B is a ternary intermetallic compound that is magnetically hard. That is, the main phase grain 4 containing the crystal of R₂T₁₄B is a hard magnetic material. The main phase grain 4 may consist of only the crystals of R₂T₁₄B. The crystal of R₂T₁₄B may be a tetragonal crystal. Crystal axes of R₂T₁₄B are referred to as an a-axis, a b-axis, and a c-axis. The a-axis, the b-axis, and the c-axis may be orthogonal to each other. A lattice constant of R₂T₁₄B in the a-axis direction may be equal to a lattice constant of R₂T₁₄B in the b-axis direction, and a lattice constant of R₂T₁₄B in the c-axis direction may be different from the lattice constant in each of the a-axis direction and the b-axis direction. The c-axis of R₂T₁₄B may be substantially or completely parallel to the easy magnetization axis direction C of the hot deformed magnet 2. In other words, a (001) plane of the tetragonal crystal of R₂T₁₄B may be substantially or completely perpendicular to the easy magnetization axis direction C of the hot deformed magnet 2.

For example, R₂T₁₄B configuring the main phase grain 4 may be represented as (Nd₁₋ₓPrₓ)₂(Fe_{1-y}Co_{y})₁₄B. The x may be 0 or more and less than 1. The y may be 0 or more and less than 1. The main phase grain 4 may include the heavy rare-earth element such as Tb and Dy, in addition to a light rare-earth element, as the rare-earth element R. The main phase grain 4 may contain other elements in addition to R, T, and B. For example, a part of B in R₂T₁₄B may be substituted with another element such as carbon (C). A composition in the main phase grain 4 may be uniform. The composition in the main phase grain 4 may be non-uniform. For example, a concentration distribution of each of R, T, and B in the main phase grain 4 may have a gradient.

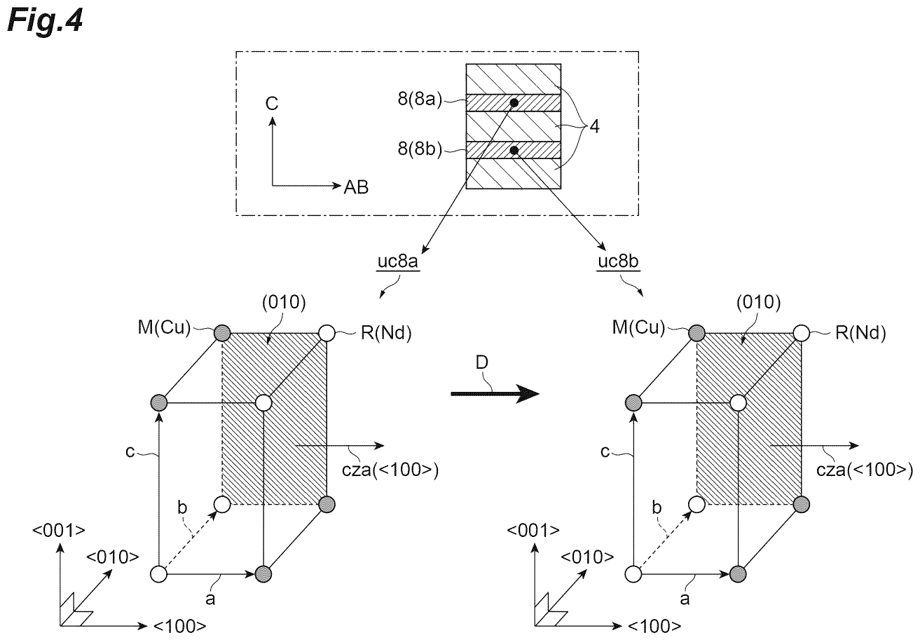

As shown in FIG. 2, the grain boundary phase 6 contains a plurality of crystal grains 8. The plurality of crystal grains 8 may be non-magnetic rather than paramagnetic. Each of the plurality of crystal grains 8 may be a single crystal or a polycrystal. As shown in FIG. 2 and FIG. 4, at least a part or all of the plurality of crystal grains 8 are in contact with one or more main phase grains 4.

A unit cell uc8a shown in FIG. 4 represents a unit cell of any one crystal grain 8a in contact with one or more main phase grains 4. Another unit cell uc8b shown in FIG. 4 represents a unit cell of another crystal grain 8b (any one crystal grain 8 different from crystal grain 8a) in contact with one or more main phase grains 4. Three basic translation vectors configuring each of the unit cell uc8a and the unit cell uc8b are represented as a vector a, a vector b, and a vector c. For example, each of the plurality of crystal grains 8 (crystal grain 8a and crystal grain 8b) may be a cubic crystal, a tetragonal crystal, or an orthorhombic crystal. In a case where the vector a, the vector b, and the vector c are perpendicular to each other and lengths of the vector a, the vector b, and the vector c are equal to each other, each of the crystal grain 8a (unit cell uc8a) and the crystal grain 8b (unit cell uc8b) is a cubic crystal. In a case where the vector a, the vector b, and the vector c are perpendicular to each other, the lengths of the vectors a and b are equal to each other, and the length of the vector c is different from the lengths of the vectors a and b, each of the crystal grain 8a (unit cell uc8a) and the crystal grain 8b (unit cell uc8b) is a tetragonal crystal. In a case where the vector a, the vector b, and the vector c are perpendicular to each other and the lengths of the vectors a and b are different from each other, each of the crystal grain 8a (unit cell uc8a) and the crystal grain 8b (unit cell uc8b) is an orthorhombic crystal. In the present disclosure, the orthorhombic crystal may imply a rhombic crystal.

As shown in FIG. 4, crystal zone axes cza of the plurality of crystal grains 8 (for example, crystal grain 8a and crystal grain 8b) in contact with one or more main phase grains 4 are oriented along a single direction (orientation direction D). The crystal zone axis cza of each of the plurality of crystal grains 8 in contact with the same main phase grain 4 may be oriented along the same direction (orientation direction D). For example, an angle between the crystal zone axes cza of any two of the plurality of crystal grains 8 may be 5° or less or 3° or less. In other words, an angle between the crystal zone axis cza of any one crystal grain 8 and the orientation direction D may be 2.5° or less or 1.5° or less. The crystal zone axes cza of the plurality of crystal grains 8 may be substantially or completely parallel to each other. That is, directions of the crystal zone axes cza of the plurality of crystal grains 8 may be identical and may coincide with the orientation direction D. The plurality of crystal grains 8 of which the crystal zone axes cza are oriented along the single direction (orientation direction D) may be locally contained only in a part of the hot deformed magnet 2. The plurality of crystal grains 8 of which the crystal zone axes cza are oriented along the single direction (orientation direction D) may exist in an entire region of the hot deformed magnet 2.

### [Definition of Crystal Zone Axis]

Any two lattice planes (for example, (hkl) plane and (h′k′l′) plane) that are not parallel in any one crystal (for example, crystal grain 8 or main phase grain 4) necessarily intersect. Each of h, k, l, h′, k′, and l′ is a Miller index. When a line intersection between the (hkl) plane and the (h′k′l′) plane is directed to a <uvw> direction, the line intersection between the (hkl) plane and the (h′k′l′) plane is defined as a crystal zone axis expressed as <uvw>. The u is equal to kl′−lk′, the v is equal to lh′−hl′, and the w is equal to hk′−kh′. The (hkl) plane and the (h′k′l′) plane belong to a crystal zone expressed as [uvw]. Since the crystal zone axis (<uvw>) is necessarily perpendicular to a normal line of the lattice plane (that is, each of (hkl) plane and (h′k′l′) plane) belonging to the crystal zone ([uvw]), the (hkl) plane, the (h′k′l′) plane, and the crystal zone axis (<uvw>) satisfy hu+kv+lw=0 and h′u+k′v+l′w=0. These formulas are referred to as the Weiss' law of zones.

### [Orientation of Crystal Zone Axis of Crystal Grain]

For example, the crystal zone axis cza of each of the plurality of crystal grains 8 may be <100>, <010>, or <001>.

For example, <100> of the plurality of crystal grains 8 in contact with one or more main phase grains 4 may be oriented along the single direction (orientation direction D). That is, an angle between <100> of any two crystal grains 8 among the plurality of crystal grains 8 may be 5° or less, or 3° or less, and an angle between <100> of any one crystal grain 8 and the orientation direction D may be 2.5° or less, or 1.5° or less.

For example, <010> of the plurality of crystal grains 8 in contact with one or more main phase grains 4 may be oriented along the single direction (orientation direction D). That is, an angle between <010> of any two crystal grains 8 among the plurality of crystal grains 8 may be 5° or less, or 3° or less, and an angle between <010> of any one crystal grain 8 and the orientation direction D may be 2.5° or less, or 1.5° or less.

For example, <001> of the plurality of crystal grains 8 in contact with one or more main phase grains 4 may be oriented along the single direction (orientation direction D). That is, an angle between <001> of any two crystal grains 8 among the plurality of crystal grains 8 may be 5° or less, or 3° or less, and an angle between <001> of any one crystal grain 8 and the orientation direction D may be 2.5° or less, or 1.5° or less.

### [Crystal Zone Axis of Crystal Grain and Crystal Zone Axis of Main Phase Grain]

For example, a crystal zone axis cza′ of each of the one or more main phase grains 4 in contact with the plurality of crystal grains 8 may be <100>, <010>, or <001>. <001> of each of the plurality of main phase grains 4 in the hot deformed magnet 2 may be substantially or completely parallel to the easy magnetization axis direction C of the hot deformed magnet 2.

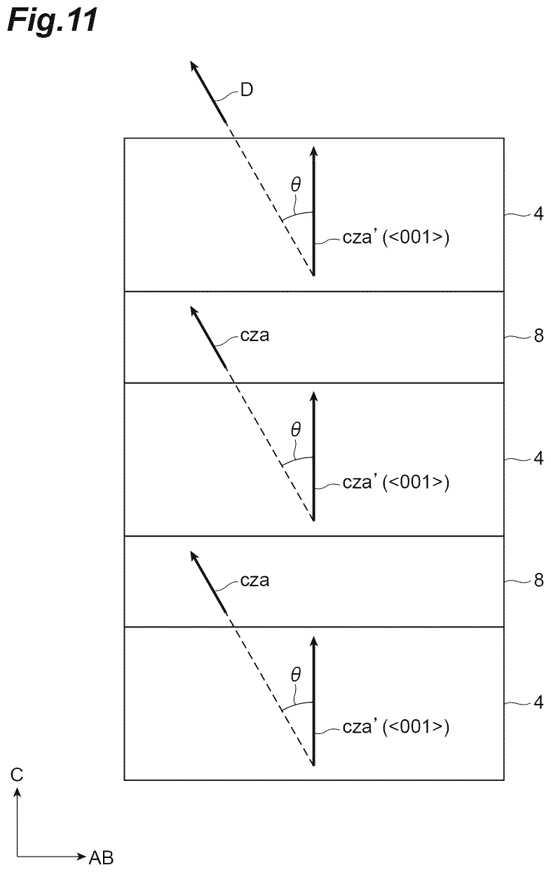

As shown in FIG. 11, an angle between the crystal zone axis cza of each of the plurality of crystal grains 8 and the crystal zone axis cza′ of each of the one or more main phase grains 4 in contact with the plurality of crystal grains 8 may be expressed as an angle θ.

For example, the angle θ may be an angle between <100> of each of the plurality of crystal grains 8 and <100> of each of the one or more main phase grains 4.

For example, the angle θ may be an angle between <010> of each of the plurality of crystal grains 8 and <010> of each of the one or more main phase grains 4.

For example, the angle θ may be an angle between <001> of each of the plurality of crystal grains 8 and <001> of each of the one or more main phase grains 4.

For example, the angle θ may be from 0° to 19.5°, from 0° to 10°, from 0° to 9.2°, from 1.5° to 19.5°, from 1.5° to 10°, or from 1.5° to 9.2°. As the angle θ decreases, a crystal structure of each crystal grain 8 in the grain boundary phase 6 and a crystal structure of each main phase grain 4 easily match at an interface therebetween. As a result, an energy barrier at the interface between the grain boundary phase 6 and the main phase grain 4 increases, and movement of a domain wall via the grain boundary phase 6 is easily suppressed. Therefore, in a case where the angle θ is 100 or less, a coercivity and a squareness ratio of the hot deformed magnet 2 easily increase.

For the same reason described above, an average value of the angle θ may be from 0° to 19.5°, from 0° to 10°, from 0° to 9.2°, from 1.5° to 19.5°, from 1.5° to 10°, or from 1.5° to 9.2°. For example, the average value of the angle θ may be an average value of the angle θ between 10 or more pairs of crystal grain 8 and the main phase grain 4.

As shown in FIG. 11, an angle between the single direction (orientation direction D) in which the crystal zone axes cza of the plurality of crystal grains 8 are oriented and the crystal zone axis cza′ of each of the one or more main phase grains 4 in contact with the plurality of crystal grains 8 may be equal to the angle θ, and may be from 0° to 19.5°, from 0° to 10°, from 0° to 9.2°, from 1.5° to 19.5°, from 1.5° to 10°, or from 1.5° to 9.2°. For example, the single direction (orientation direction D) in which the crystal zone axes cza of the plurality of crystal grains 8 are oriented may be substantially or completely parallel to the crystal zone axis cza′ of each of the one or more main phase grains 4 in contact with the plurality of crystal grains 8.

A crystal zone axis oriented along the single direction (orientation direction D), among crystal zone axes of each of the plurality of crystal grains 8 in contact with the one or more main phase grains 4, may be expressed as cza1.

A crystal zone axis, among crystal zone axes of each of the plurality of crystal grains 8 in contact with the one or more main phase grains 4, forming an angle from 0° to 10° with the crystal zone axis cza′ of each of the one or more main phase grains 4 in contact with the plurality of crystal grains 8 may be expressed as cza2.

The cza1 and the cza2 may be identical, or the cza1 and the cza2 may be different from each other. That is, the crystal zone axis cza1 of the crystal grain 8 oriented along the single direction (orientation direction D) may be identical to or different from the crystal zone axis cza2 of the crystal grain 8 forming an angle from 0° to 10° with the crystal zone axis cza′ of the main phase grain 4.

### [Measurement of Direction of Crystal Zone Axis]

The direction of the crystal zone axis cza of each of the plurality of crystal grains 8 is specified based on an electron beam diffraction pattern of each of the plurality of crystal grains 8. The electron beam diffraction pattern may be measured by selected area electron diffraction (SAED) using a transmission electron microscope (TEM) or nano beam electron diffraction (NBED) using the TEM.

An electron beam diffraction pattern of any one crystal grain 8 is obtained by directing an incident electron beam into the cross section of the crystal grain 8 exposed on the cross section 2cs of the hot deformed magnet 2. As described above, the cross section 2cs of the hot deformed magnet 2 is substantially or completely parallel to the easy magnetization axis direction C. The electron beam diffraction pattern contains a plurality of diffraction spots derived from a plurality of lattice planes in the single crystal grain 8. A spot (center spot expressed as (000)) positioned at the center of the electron beam diffraction pattern is a spot of an electron beam passed through the crystal grain 8 without being diffracted on each lattice plane in the crystal grain 8. For example, a direction of the crystal zone axis cza expressed as <uvw> may be a direction of a straight line passing through a center of a diffraction spot derived from a lattice plane expressed as a (uvw) plane and a center of the center spot. A direction of the crystal zone axis cza expressed as <uvw> may be a direction of a straight line passing through a spot derived from the lattice plane parallel to the (uvw) plane and the center of the center spot.

The direction of the crystal zone axis cza of each of the plurality of crystal grains 8 is specified by the above method. By comparing the electron beam diffraction patterns of the plurality of crystal grains 8 with each other, it is possible to confirm whether or not the crystal zone axes cza of the plurality of crystal grains 8 are oriented along the single direction (orientation direction D). For example, in a case where the respective electron beam diffraction patterns of the plurality of crystal grains 8 substantially or completely match at a position of each diffraction spot derived from each lattice plane and in a direction in which the plurality of diffraction spots are arranged, the crystal zone axes cza of the plurality of crystal grains 8 are substantially or completely parallel to each other.

The direction of the crystal zone axis cza′ of each of the one or more main phase grains 4 in contact with the plurality of crystal grains 8 is specified by a method similar to the above method. That is, the direction of the crystal zone axis cza′ of each of the one or more main phase grains 4 in contact with the plurality of crystal grains 8 is specified based on the electron beam diffraction pattern of each main phase grain 4. An electron beam diffraction pattern of any one main phase grain 4 is obtained by directing an incident electron beam into the cross section of any one main phase grain 4 exposed on the cross section 2cs of the hot deformed magnet 2. The crystal structure of each main phase grain 4 may also be specified based on the electron beam diffraction pattern of each main phase grain 4.

### [Method for Measuring Angle θ]

The angle θ described above may be measured by the following method using the TEM.

A sample (thin piece) is prepared from the hot deformed magnet 2 by a processing method such as milling using a focused ion beam (FIB). A thickness of the sample is adjusted to a thickness (usually 100 nm or less) suitable for the analysis using the TEM.

Since a thickness of the grain boundary phase 6 in the sample is about several nanometers, the TEM is set to a nano beam diffraction mode.

A crystal structure of each crystal grain 8 in the sample and a crystal structure of each main phase grain 4 in contact with each crystal grain 8 in the sample are specified in advance by the above method. A tilt angle of a stage where the sample is installed in the TEM is adjusted so that a direction of an incident electron beam into the crystal grain 8 in the sample is parallel to <uvw> (that is, normal line of (uvw) plane) of the crystal grain 8 in the sample. That is, in a state where the electron beam is parallel to <uvw> (crystal zone axis) of the crystal grain 8, the electron diffraction pattern of the crystal grain 8 is measured. For example, in a state where the electron beam is parallel to <001> (that is, normal line of (001) plane) of the crystal grain 8 in the sample, the electron diffraction pattern of the crystal grain 8 is measured. From this electron beam diffraction pattern, the direction of <uvw> (for example, <001>) of the crystal grain 8 in the sample is specified.

The tilt angle (tilt angle) of the stage where the sample is installed in the TEM is adjusted so that a direction of an incident electron beam into the main phase grain 4 in contact with the crystal grain 8 in the sample is parallel to <uvw> (that is, normal line of (uvw) plane) of the main phase grain 4 in the sample. That is, in a state where the electron beam is parallel to <uvw> (crystal zone axis) of the main phase grain 4, an electron diffraction pattern of the main phase grain 4 is measured. For example, in a state where the electron beam is parallel to <001> of the main phase grain 4 in the sample, an electron diffraction pattern of the main phase grain 4 is measured. From this electron beam diffraction pattern, the direction of <uvw> (for example, <001>) of the main phase grain 4 in the sample is specified.

The electron diffraction pattern of each of the crystal grain 8 and the main phase grain 4 may be taken by a digital camera or a CCD camera and may be analyzed as image data with a high resolution.

The angle θ is specified based on the direction of <uvw> (crystal zone axis) of each of the crystal grain 8 and the main phase grain 4 in the sample. For example, a unit vector e1 parallel to <uvw> of the crystal grain 8 may be specified from a position of the diffraction spot corresponding to <uvw> of the crystal grain 8, and a unit vector e2 parallel to <uvw> of the main phase grain 4 may be specified from a position of the diffraction spot corresponding to <uvw> of the main phase grain 4. The angle θ may be calculated from a mathematical formula expressed as 0=(180°/π)×arccos <e1,e2>. <e1,e2> in the mathematical formula is an inner product of e1 and e2.

For example, two vectors respectively corresponding to <uvw> of the crystal grain 8 and <uvw> of the main phase grain 4 may be visualized based on the image data of the electron diffraction pattern of each of the crystal grain 8 and the main phase grain 4, and an angle between the two vectors may be measured by a protractor.

The hot deformed magnet 2 according to the present disclosure can have a high coercivity due to the following mechanism.

According to the hot deformed magnet 2 in which the crystal zone axes cza of the plurality of crystal grains 8 in contact with the one or more main phase grains 4 are oriented along the single orientation direction D, a pining force of the domain wall in the grain boundary phase 6 containing the plurality of crystal grains 8 increases, as compared with a hot deformed magnet in which the crystal zone axes cza of the plurality of crystal grains 8 are not oriented. As a result, magnetization reversal caused by the movement of the domain wall is suppressed, and each of the plurality of main phase grains 4 is likely to be in a magnetic single domain state, and the coercivity (HcJ) of the hot deformed magnet 2 increases. Moreover, the crystal zone axes cza of the plurality of crystal grains 8 are oriented, so that magnetic decoupling between the plurality of main phase grains 4 easily occurs. Due to the magnetic decoupling, the squareness ratio of the hot deformed magnet 2 (Hk/HcJ) easily increases, while maintaining a high coercivity. Hk is an intensity of a demagnetizing field corresponding to 90% of a residual magnetic flux density in a second quadrant of a magnetization curve of the hot deformed magnet 2.

In contrast, in a case where the grain boundary phase 6 is ferromagnetic, or in a case where the directions of the crystal zone axes cza of the plurality of crystal grains 8 in the grain boundary phase 6 are random, a multi-magnetic domain state where the domain wall penetrates inside of the main phase grain 4 easily occurs, the magnetization reversal caused by the movement of the domain wall easily occurs, and the coercivity is lowered.

In conventional studies relating to the hot deformed magnet, a macrostructure containing the main phase grain and the grain boundary phase (for example, morphology relating to main phase grain and grain boundary phase) has attracted attention. However, in conventional studies, a microstructure (for example, structure and crystal orientation of crystal in grain boundary phase) in the grain boundary phase 6 has not been mentioned. An influence of the orientations of the crystal zone axes cza of the plurality of crystal grains 8 in the grain boundary phase 6 on the coercivity and the squareness ratio has been discovered for the first time by the inventors of the present disclosure.

A technical range of the hot deformed magnet 2 according to the present disclosure is not limited by the above mechanism.

For example, the coercivity (HcJ) of the hot deformed magnet 2 at 23° C. may be from 1313 kA/m to 1591 kA/m.

For example, the residual magnetic flux density (Br) of the hot deformed magnet 2 at room temperature may be from 1.25 T to 1.47 T or from 1.25 T to 1.46 T.

For example, the squareness ratio (Hk/HcJ) of the hot deformed magnet 2 may be from 90.5% to 98.5% or from 90.5% to 98.2%.

An angle between the single direction (orientation direction D) in which the crystal zone axes cza of the plurality of crystal grains 8 in contact with the one or more main phase grains 4 are oriented and the easy magnetization axis direction C is not particularly limited. For the reason that the coercivity and the squareness ratio easily increase, the crystal structures of the plurality of crystal grains 8 in contact with the one or more main phase grains 4 may be identical to each other. For the same reason, compositions of the plurality of crystal grains 8 in contact with the one or more main phase grains 4 may be the same.

However, the crystal structures of the plurality of crystal grains 8 in contact with the one or more main phase grains 4 may be different from each other. That is, the crystal zone axes cza of the plurality of crystal grains 8 different in the crystal structure may be oriented along the single direction (orientation direction D). The compositions of the plurality of crystal grains 8 in contact with the one or more main phase grains 4 may be different from each other. That is, the crystal zone axes cza of the plurality of crystal grains 8 different in the composition may be oriented in the single direction (orientation direction D).

The compositions of the plurality of crystal grains 8 are different from the compositions of the plurality of main phase grains 4. For example, the plurality of crystal grains 8 may contain at least one rare-earth element R and at least one element M. The plurality of crystal grains 8 may contain at least Nd, as the rare-earth element R. The element M contained in the plurality of crystal grains 8 may be at least one selected from the group consisting of copper (Cu), gallium (Ga), zinc (Zn), nickel (Ni), and chrome (Cr). An element M contained in one crystal grain 8 may be an element different from an element M contained in another crystal grain 8. The plurality of crystal grains 8 may consist of only the rare-earth element R and the element M. For example, the plurality of crystal grains 8 may further contain another element, in addition to the rare-earth element R and the element M. For example, the plurality of crystal grains 8 may further contain at least one of Fe and Co, as the transition metal element T. The plurality of crystal grains 8 may consist of only the rare-earth element R, the element M, and the transition metal element T.

The plurality of crystal grains 8 may be an intermetallic compound containing the rare-earth element R and the element M. For example, as shown in FIG. 4, the unit cells (unit cell uc8a and unit cell uc8b) of the plurality of crystal grains 8 may contain the rare-earth element R and the element M. For example, a part of the rare-earth elements R in the unit cells of the plurality of crystal grains 8 may be substituted with the transition metal element T or the other elements. For example, a part of the elements M in the unit cells of the plurality of crystal grains 8 may be substituted with the transition metal element T or the other elements.

A content (unit: mass %) of the rare-earth element R in the plurality of crystal grains 8 may be larger than a content of the rare-earth element R in the plurality of main phase grains 4. A concentration (unit: atom %) of the rare-earth element R in the plurality of crystal grains 8 may be higher than a concentration of the rare-earth element R in the plurality of main phase grains 4. That is, the rare-earth element R may be enriched in the plurality of crystal grains 8. Due to the enrichment of the rare-earth element R in the plurality of crystal grains 8, the plurality of crystal grains 8 easily become non-magnetic. As a result, the magnetic decoupling between the main phase grains 4 due to the plurality of crystal grains 8 easily occurs, and the coercivity and the squareness ratio easily increase.

Since Nd ions are easily exposed on the surface ((001) plane of R₂T₁₄B) of each main phase grain 4, the easy magnetization axis direction C is easily directed locally in an in-plane direction of the surface of each main phase grain 4. That is, the easy magnetization axis direction C easily and locally becomes parallel to the surface of each main phase grain 4. As a result, the surface of each main phase grain 4 easily becomes a nucleus generating magnetization reversal, and the coercivity is easily lowered. However, a part of Fe positioned on the surface of the main phase grain 4 is substituted with the element M at the interface between the main phase grain 4 and the crystal grain 8, and as a result, a direction of a crystalline electric field (anisotropy field) acting on 4f electrons of the Nd ions exposed on the surface of the main phase grain 4 is easily changed from the in-plane direction of the surface of each main phase grain 4 to a normal direction of the surface of each main phase grain 4. That is, due to the element M derived from the plurality of crystal grains 8, the easy magnetization axis direction C on the surface of each main phase grain 4 easily has uniaxial anisotropy similar to the inside (bulk) of each main phase grain 4. As a result, the magnetization reversal caused by the surface of each main phase grain 4 is easily suppressed, and the coercivity easily increases.

The content of the rare-earth element R in the plurality of crystal grains 8 may be from 50 mass % to 98 mass %, from 60 mass % to 80 mass %, or from 53.40 mass % to 96.27 mass %. A content of the transition metal element T in the plurality of crystal grains 8 may be from 0 mass % to 50 mass %, from 0 mass % to 20 mass %, from 0 mass % to 10 mass %, or from 3.20 mass % to 40.93 mass %. A content of the element M in the plurality of crystal grains 8 may be more than 0 mass % and 35 mass % or less, from 2 mass % to 30 mass %, from 20 mass % to 30 mass %, or from 0.53 mass % to 31.54 mass %. The plurality of crystal grains 8 having the above composition easily become non-magnetic. The plurality of non-magnetic crystal grains 8 may be defined as the plurality of crystal grains 8 represented by the following chemical formula 1 or chemical formula 2.

R_{α}T_{β}M_{γ} (1)

The α in the chemical formula 1 above may be from 50 mass % to 98 mass %, from 60 mass % to 80 mass %, or from 53.40 mass % to 96.27 mass %, the β in the chemical formula 1 above may be from 0 mass % to 50 mass %, from 0 mass % to 20 mass %, from 0 mass % to 10 mass %, or from 3.20 mass % to 40.93 mass %, and the γ in the chemical formula 1 above may be more than 0 mass % and 35 mass % or less, from 2 mass % to 30 mass %, from 20 mass % to 30 mass %, or from 0.53 mass % to 31.54 mass %

R_{A}T_{B}M_{C} (2)

The A in the chemical formula 2 above may be from 40 atom % to 94 atom % or from 31.2 atom % to 76.6 atom %, the B in the chemical formula 2 above may be from 0 atom % to 30 atom % or from 6.4 atom % to 61.7 atom %, and the C in the chemical formula 2 above may be from 0.9 atom % to 50 atom % or from 0.9 atom % to 48.3 atom %.

The R in the chemical formulas 1 and 2 is the rare-earth element R described above, the T in the chemical formulas 1 and 2 is the transition metal element T described above, and the M in the chemical formulas 1 and 2 is the element M described above.

For the reason that the coercivity and the squareness ratio easily increase, at least a part or all of the plurality of crystal grains 8 in contact with the one or more main phase grains 4 may contain Nd and Cu. For example, as shown in FIG. 4, the unit cells (unit cell uc8a and unit cell uc8b) of the plurality of crystal grains 8 may contain Nd as the rare-earth element R and Cu as the element M. The plurality of crystal grains 8 containing Nd and Cu may further contain the transition metal element T. For the reason that the coercivity and the squareness ratio easily increase, each of the plurality of crystal grains 8 containing Nd and Cu may be a cubic crystal, a tetragonal crystal, or an orthorhombic crystal. For the reason that the coercivity and the squareness ratio easily increase, a space group indicating symmetry of the crystal structure of each of the plurality of crystal grains 8 containing Nd and Cu may be Pnma, I4/mcm, Fm-3m, or Ia-3. Notation of the space group is based on the Hermann-Mauguin notation. For the reason that the coercivity and the squareness ratio easily increase, as shown in FIG. 4, <100> of the plurality of crystal grains 8 containing Nd and Cu may be oriented along the single direction (orientation direction D). For the reason that the coercivity and the squareness ratio easily increase, as shown in FIG. 4, (010) planes of the plurality of crystal grains 8 containing Nd and Cu may be substantially or completely parallel to each other.

The crystal structure of each crystal grain 8 and the space group indicating the symmetry of the crystal structure may be specified based on the electron beam diffraction pattern of each crystal grain 8. By referring to a known database regarding the crystal structure (for example, Inorganic Crystal Structure Database (ICSD)), Miller indices h, k, and l (that is, (hkl) plane) corresponding to each of the plurality of spots (bright point) in the electron beam diffraction pattern are identified. The plurality of spots in the electron beam diffraction pattern is not uniform, and the plurality of spots are different in luminance, and some spots disappear at specific positions. By confirming whether or not the electron beam diffraction pattern corresponds to a known systematic extinction rule and symmetry element, candidates of the space group are narrowed. An electron beam diffraction pattern corresponding to the space group estimated by the above method is reproduced by simulation software (for example, JEMS Electron Microscopy Software). By making the reproduced electron beam diffraction pattern match an electron diffraction pattern that has been actually measured, an actual space group is specified. That is, by repeating the above analysis until the electron beam diffraction pattern reproduced by the simulation software matches the electron diffraction pattern that has been actually measured, the actual space group is specified.

As described above, the plurality of crystal grains 8 are not limited to orthorhombic crystals containing Nd and Cu. As described above, at least a part of the plurality of crystal grains 8 may be a cubic crystal or a tetragonal crystal. For example, at least a part of the plurality of crystal grains 8 may be a tetragonal crystal containing Nd and Ga. For example, at least a part of the plurality of crystal grains 8 may be an Nd-rich phase (for example, phase containing Nd₆Fe₁₃Ga).

The compositions of the plurality of crystal grains 8 may be distinguished from compositions of the plurality of main phase grains 4 and other components, based on their compositions. The composition of the plurality of crystal grains 8 may be measured by an energy dispersive X-ray spectroscopy (EDS) equipped in a scanning transmission electron microscope (STEM) or in a scanning electron microscope (SEM). For example, an image of the cross section of the hot deformed magnet 2 may be taken by the STEM or the SEM, and the compositions of the plurality of crystal grains 8 may be measured by the EDS in the image of the cross section. Moreover, according to element mapping by the EDS, the plurality of crystal grains 8 exposed on the cross section of the hot deformed magnet 2 may be distinguished from the plurality of main phase grains 4 and the other components. The compositions of the plurality of main phase grains 4 and the other components may be measured by the above method. Note that a place same as the TEM image can be observed by the STEM, using a sample observed by the TEM. That is, a composition of a place where the crystal zone axis and the angle θ are measured by the TEM can be measured by the STEM-EDS.

The grain boundary phase 6 may contain an oxide of the rare-earth element R. At least a part or all of the plurality of crystal grains 8 may be an oxide of the rare-earth element R. For example, the oxide of the rare-earth element R may be at least one of Nd₂O₃ having a hexagonal crystal structure and a NdO having a face-centered structure. The oxide of the rare-earth element R may be one kind of an R-rich phase to be described later.

The grain boundary phase 6 may contain metallic neodymium (simple substance of Nd) having a hexagonal close-packed structure. At least a part or all of the plurality of crystal grains 8 may be metallic neodymium having the hexagonal close-packed structure. The metallic neodymium may be one kind of the R-rich phase to be described later.

The plurality of crystal grains 8 containing the rare-earth element R and the element M may be one kind of the following R-rich phase.

The grain boundary phase 6 may contain the R-rich phase. The R-rich phase contains at least the rare-earth element R. For example, the R-rich phase may contain Nd, as the rare-earth element R. The R-rich phase may further contain one or more kinds of other rare-earth elements, in addition to Nd, as the rare-earth element R. The R-rich phase may further contain one or more kinds of elements other than the rare-earth element R. The R-rich phase may contain at least one of a simple substance of the rare-earth element R, an alloy containing the rare-earth element R, and a metal compound containing the rare-earth element R. A concentration (unit: atom %) of the rare-earth element R in the R-rich phase may be higher than an average value of the concentrations of the rare-earth element R in the main phase grains 4. The concentration of R in the R-rich phase may be higher than the average value of the concentrations of the rare-earth element R in the cross section 2cs. In a case where the hot deformed magnet 2 includes the plurality of kinds of rare-earth elements R, the concentration of the rare-earth element R may be a sum of concentrations of the plurality of kinds of rare-earth elements R.

The grain boundary phase 6 may further contain a paramagnetic phase having a larger content of the transition metal element T than the plurality of crystal grains 8. For example, the content of the transition metal element T in the paramagnetic phase may be from 60 mass % to 100 mass %. The paramagnetic phase may further contain the rare-earth element R.

An area fraction AR (phase fraction) of cross sections of the plurality of crystal grains 8 in the cross section 2cs of the hot deformed magnet 2 may be from 3.0% to 8.0%. The cross section 2cs where the area fraction is measured is substantially or completely parallel to the easy magnetization axis direction C of the hot deformed magnet 2. In a case where the area fraction AR is 3.0% or more, the coercivity and the squareness ratio easily increase. In a case where the area fraction AR is 8.0% or less, the coercivity easily increases, and a decrease in the residual magnetic flux density caused by the plurality of crystal grains 8 is easily suppressed. For the reason that the coercivity and the squareness ratio easily increase and the decrease in the residual magnetic flux density is easily suppressed, the area fraction AR may be from 3.2% to 6.3%.

The area fraction AR may be expressed as Acr/Acs (unit: %). The Acr is a total of the areas of the cross sections of the plurality of crystal grains 8. The Acs is an area of a cross section where Acr is measured. The cross section where Acr is measured may be whole or a part of the cross section 2cs of the hot deformed magnet 2. That is, Acs may be an entire area of the cross section 2cs of the hot deformed magnet 2 or may be a part of an area of the cross section 2cs.

The total Acr of the areas of the cross sections of the plurality of crystal grains 8 may be measured by the following method.

An image of the cross section 2cs of the hot deformed magnet 2 is taken by the TEM or the SEM. A monochrome image is obtained by threshold processing (binarization processing) of the image of the cross section 2cs using image analysis software. By adjusting a threshold of the binarization processing to an appropriate value, the plurality of crystal grains 8 in the monochrome image can be distinguished from the compositions of the plurality of main phase grains 4 and the other components, based on a contrast. Moreover, a contour of the cross section of each of the plurality of crystal grains 8 is specified by the image analysis software, and an area of the cross section of each of the plurality of crystal grains 8 is measured by the image analysis software. From the area of the cross section of each of the plurality of crystal grains 8, the total Acr of the areas of the cross sections of the plurality of crystal grains 8 is calculated. As the image analysis software, ImageJ that is public-domain image analysis software or another commercially available image analysis software may be used.

For example, a volume ratio of the plurality of main phase grains 4 (ratio of volume of all main phase grains 4 in hot deformed magnet 2) may be 80 vol % or more and less than 100 vol % or may be from 92 vol % to 97 vol %.

As shown in FIG. 2, a width W (for example, average value of width W) of the grain boundary phase 6 containing the one or more crystal grains 8 in contact with the one or more main phase grains 4 may be from 4 nm to 500 nm in the easy magnetization axis direction C of the hot deformed magnet 2. In other words, the width W of the grain boundary phase 6 that is positioned between the pair of main phase grains 4 and contains the one or more crystal grains 8 may be from 4 nm to 500 nm in the easy magnetization axis direction C of the hot deformed magnet 2. In a case where the width W of the grain boundary phase 6 is 4 nm or more, the one or more crystal grains 8 (crystalline non-magnetic phase) are easily formed in the grain boundary phase 6, and the coercivity and the squareness ratio of the hot deformed magnet 2 easily increase. In a case where the width W of the grain boundary phase 6 is 500 nm or less, a volume of the grain boundary phase 6 that is not magnetically hard is moderately suppressed, and the decrease in the residual magnetic flux density of the hot deformed magnet 2 is easily suppressed. For the reason that the coercivity and the squareness ratio easily increase and the decrease in the residual magnetic flux density is easily suppressed, the width W of the grain boundary phase 6 may be from 7.1 nm to 27.0 nm or from 7.5 nm to 27.0 nm.

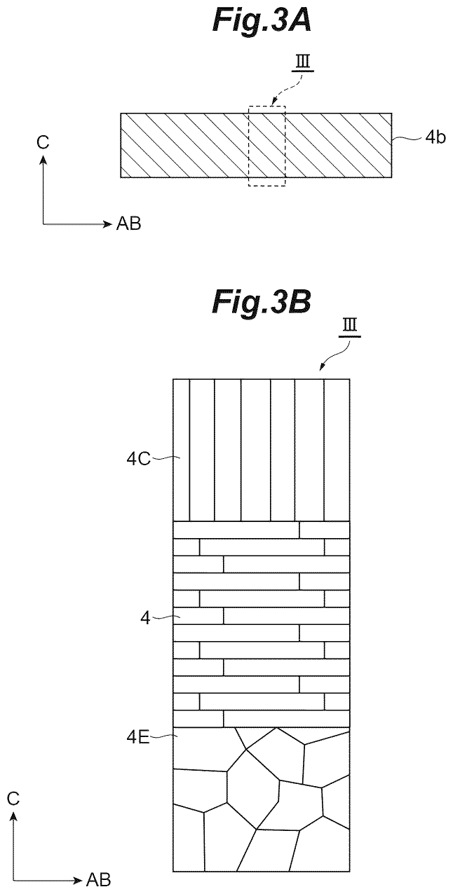

The one or more main phase grains 4 (secondary grain) in contact with the one or more crystal grains 8 may contain at least one of a columnar crystal and an equiaxed crystal. For example, as shown in FIG. 3A and FIG. 3B, a single secondary grain 4b may contain a plurality of columnar crystals 4C, the plurality of platelet-shaped main phase grains 4 (primary grain), and a plurality of equiaxed crystals 4E. The columnar crystal 4C in the secondary grain 4b may extend along the easy magnetization axis direction C. The platelet-shaped main phase grain 4 (primary grain) in the secondary grain 4b may extend along the AB direction orthogonal to the easy magnetization axis direction C. The equiaxed crystal 4E may be referred to as an isotropic crystal in a shape and a crystal orientation. The columnar crystal 4C tend to be positioned in the vicinity of one surface of the platelet-shaped secondary grain 4b. The equiaxed crystal 4E tends to be positioned in the vicinity of another surface of the platelet-shaped secondary grain 4b. The platelet-shaped main phase grain 4 (primary grain) tends to be positioned between the columnar crystal 4C and the equiaxed crystal 4E. Each of the single columnar crystal 4C and the single equiaxed crystal 4E may be a single main phase grain (primary grain).

The columnar crystal 4C and the equiaxed crystal 4E may be derived from an alloy ribbon that is a raw material of the hot deformed magnet 2. That is, the alloy ribbon may be a precursor of the secondary grain 4b. The alloy ribbon is prepared by a rapid-solidification method to be described later. In the rapid-solidification method, molten metal containing a plurality of kinds of elements configuring the hot deformed magnet 2 comes into contact with a surface of a cooled roll and is cooled. As a result, the molten metal is solidified, and the alloy ribbon is formed.

At a portion (contact portion) of the molten metal in contact with the surface of the cooled roll, the molten metal is rapidly cooled, and a chill layer (for example, layer containing a plurality of nanoscale fine crystal grains) is easily formed in the vicinity of a surface of the alloy ribbon. A plurality of crystal grains in the chill layer is heated in a hot pressing step or a hot deforming step. As a result, growth of a coarse crystal grain derived from the chill layer rapidly proceeds in the vicinity of the surface of the alloy ribbon, and the coarse equiaxed crystal 4E is easily formed in the vicinity of the surface of the platelet-shaped secondary grain 4b.

On the other hand, since a portion (non-contact portion) of the molten metal positioned on a back side of the contact portion is not in contact with the cooled roll and is the farthest from the surface of the cooled roll, a cooling speed of the non-contact portion is lower than a cooling speed of other portions of the molten metal. Therefore, a temperature gradient in the molten metal occurs along a direction from the non-contact portion toward the contact portion. Depending on the temperature gradient of the molten metal, in a process of solidification and crystallization of the molten metal, the plurality of columnar crystals 4C extending along a thickness direction of the alloy ribbon is easily formed in the vicinity of the surface of the alloy ribbon (back side of surface where chill layer which is precursor of equiaxed crystal 4E is positioned).

A cooling speed of a portion (inside of molten metal) between the contact portion and the non-contact portion of the molten metal is lower than the cooling speed of the contact portion and is higher than the cooling speed of the non-contact portion. Therefore, a plurality of crystal grains having a grain diameter of about several tens of nanometers (crystal grain larger than crystal grain in chill layer) are easily formed inside molten metal. Each crystal grain formed inside the molten metal anisotropically grows along the AB direction orthogonal to the easy magnetization axis direction C in the hot deforming step and becomes the platelet-shaped main phase grain 4.

The inventors presume that, since the plurality of fine crystal grains contained in the alloy ribbon and the plurality of coarse crystal grains are difficult to be oriented due to normal grain boundary sliding in the hot deforming step, the columnar crystal 4C and the equiaxed crystal 4E are easily formed.

The plurality of crystal grains 8, whose crystal zone axes cza are oriented along the single direction (orientation direction D), tends to exist in the vicinity of the columnar crystal 4C or the equiaxed crystal 4E. That is, the crystal zone axes cza of the plurality of crystal grains 8 in contact with the one or more columnar crystals 4C or equiaxed crystals 4E may be oriented along the single direction (orientation direction D). The grain boundary phase 6 may exist between the plurality of main phase grains 4 contained in the single secondary grain 4b. The grain boundary phase 6 in the secondary grain 4b may contain the plurality of crystal grains 8. The plurality of crystal grains 8 in the secondary grain 4b may be in contact with the one or more main phase grains 4 in the secondary grain 4b. The crystal zone axes cza of the plurality of crystal grains 8 in contact with the one or more main phase grains 4 in the secondary grain 4b may be oriented along the single direction (orientation direction D).

As shown in FIG. 2, the plurality of main phase grains 4 observed in the cross section 2cs parallel to the easy magnetization axis direction C may have a platelet shape (flat shape). In other words, the main phase grain 4 observed in the cross section 2cs may have a plate-like shape. The plurality of platelet-shaped main phase grains 4 may be stacked along the easy magnetization axis direction C.

A width S of each of the plurality of main phase grains 4 (primary grain) in the easy magnetization axis direction C may be narrower than a width L of each of the plurality of main phase grains 4 in the AB direction perpendicular to the easy magnetization axis direction C. In other words, a length (S) of a short axis of each main phase grain 4 may be shorter than a length (L) of a long axis of each main phase grain 4. The width S (for example, average value of width S) of each main phase grain 4 in the easy magnetization axis direction C may be from 20 nm to 200 nm, from 65 nm to 77 nm, or from 66 nm to 75 nm. The width L (for example, average value of width L) of each main phase grain 4 in the AB direction perpendicular to the easy magnetization axis direction C may be from 100 nm to 1000 nm. For example, an aspect ratio L/S (for example, average value of aspect ratio L/S) of each of the plurality of main phase grains 4 may be from 2 to 10. Since the aspect ratio L/S is 2 or more, the c-axis of the main phase grain 4 is easily oriented in the easy magnetization axis direction C, and the coercivity easily increases. The aspect ratio L/S of 2 or more indicates that anisotropic grain growth of the main phase grain 4 (crystal of R₂T₁₄B) sufficiently proceeds in the hot deforming step to be described later. Since there is a limit in the anisotropic grain growth of the main phase grain 4 in the hot deforming step, the aspect ratio L/S is less likely to exceed 10.

A dimension of each of the plurality of crystal grains 8 may be about the same as a dimension of each of the plurality of main phase grains 4. The dimension of each of the plurality of crystal grains 8 may be smaller than the dimension of each of the plurality of main phase grains 4. A shape of each of the plurality of crystal grains 8 is not limited.

The shape of the main phase grain 4 in the cross section 2cs is not limited to a rectangle. The shape of the main phase grain 4 in the cross section 2cs may be distorted. The shape of the main phase grain 4 in the cross section 2cs does not need to be uniform. In a case where the shape of the main phase grain 4 in the cross section 2cs is distorted, the shape of the main phase grain 4 may be approximated by a quadrangle having the smallest area among quadrangles circumscribing the main phase grain 4. The quadrangle may be a rectangle. A length of a short side of the quadrangle may be regarded as the length (S) of the short axis of the main phase grain 4, and a length of a long side of the quadrangle may be regarded as the length (L) of the long axis of the main phase grain 4. An average value of the lengths of the short axes of the main phase grains 4 may be calculated from measurement values of the lengths of the short axes of all the main phase grains 4 existing in a backscattered electron image of the cross section 2cs taken by the SEM. An average value of the lengths of the long axes of the main phase grains 4 may be also calculated from measurement values of the lengths of the long axes of all the main phase grains 4 existing in the backscattered electron image. However, a dimension of the main phase grain 4 protruding from the backscattered electron image is excluded from the calculation of the average value. For example, a maximum value of a dimension of the backscattered electron image used to measure the length of each of the short axis and the long axis of the main phase grain 4 may be 120 μm in length x 80 μm in width, or 80 μm in length x 120 μm in width. A plurality of representative positions in the backscattered electron image taken at a low magnification may be selected, and the backscattered electron image at each position may be taken at a high magnification. Then, from the length of each of the long axes and the short axes of all the main phase grains 4 measured in the backscattered electron image at the high magnification, the average value of each of the long axes and the short axes may be calculated. The image analysis software (for example, ImageJ described above) may be used to specify the shape (contour line) of the main phase grain 4 and to measure the dimension of the main phase grain 4 (quadrangle circumscribing main phase grain 4).

The main phase grain 4 may be composed of a surface layer portion and a center portion covered with the surface layer portion. The surface layer portion may be referred to as a shell, and the center portion may be referred to as a core. The surface layer portion of the main phase grain 4 may contain at least one kind of heavy rare-earth element of Tb and Dy. The surface layer portion of each of all the main phase grains 4 may contain at least one kind of heavy rare-earth element of Tb and Dy. The surface layer portion of a part of main phase grains 4 of all the main phase grains 4 may contain at least one kind of heavy rare-earth element of Tb and Dy. Since the surface layer portion contains the heavy rare-earth element, the anisotropy field locally and easily increases in the vicinity of the grain boundary, and a nucleus of the magnetization reversal is less likely to occur in the vicinity of the grain boundary. As a result, the coercivity of the hot deformed magnet 2 at a high temperature (for example, 100° C. to 200° C.) increases. For the reason that it is easy to achieve both of the residual magnetic flux density (Br) and the coercivity of the hot deformed magnet 2, a total of concentrations of the heavy rare-earth elements in the surface layer portion may be higher than a total of concentrations of the heavy rare-earth elements in the center portion.

For example, a dimension of the hot deformed magnet 2 in the easy magnetization axis direction C may be from several mm to several hundreds of mm, or from several tens of mm to several hundreds of mm. For example, a dimension of the hot deformed magnet 2 in the AB direction may be from several mm to several hundreds of mm, or from several tens of mm to several hundreds of mm.

A composition of the whole of the hot deformed magnet 2 is described below. However, the composition of the hot deformed magnet 2 is not limited to the following composition. A content of each element in the hot deformed magnet 2 may be out of the following range.

A content of the rare-earth element R in the hot deformed magnet 2 may be from 26.00 mass % to 32.00 mass %, or from 28.00 mass % to 32.00 mass %. In a case where the content of the rare-earth element R is 26.00 mass % or more, a liquid phase (R-rich phase) is easily generated in the grain boundary in a process of manufacturing the hot deformed magnet 2, the main phase grain 4 is easily oriented due to grain boundary sliding, and the coercivity of the hot deformed magnet 2 easily increases. On the other hand, in a case where the content of R is 32.00 mass % or less, generation of an excessive liquid phase (R-rich phase) is suppressed, and a volume ratio of a main phase easily increases.

For the reason that the residual magnetic flux density and the coercivity easily increase, a total of ratios of Nd and Pr in all the rare-earth elements R may be from 80 atom % to 100 atom %, or from 95 atom % to 100 atom %.

A total value of contents of Tb and Dy in the hot deformed magnet 2 may be from 0.00 mass % to 5.00 mass %. Since the hot deformed magnet 2 contains at least one kind of heavy rare-earth element of Tb and Dy, magnetic characteristics (particularly, coercivity at high temperature) of the hot deformed magnet 2 easily increase. However, the hot deformed magnet 2 does not need to contain Tb and Dy.

A content of B in the hot deformed magnet 2 may be from 0.77 mass % to 1.15 mass %. In a case where the content of B is 0.77 mass % or more, formation of a foreign phase (heterogeneous phase) such as a TbCu₇-type R₂Fe₁₇ phase having in-plane anisotropy is moderately suppressed, and the coercivity easily increases. In a case where the content of B is 1.15 mass % or less, formation of the foreign phase such as R₁+_{ε}Fe₄B₄(Boride) is suppressed, and the coercivity easily increases. In a case where the content of B is within the above range, the squareness ratio of the hot deformed magnet 2 easily approaches 1.0.

The hot deformed magnet 2 may further contain the element M. The element M may be at least one selected from the group consisting of Cu, Ga, Zn, Ni, and Cr. A content of the element M in the hot deformed magnet 2 may from 0.67 mass % to 7.30 mass %. In a case where the content of the element M is 0.67 mass % or more, the plurality of non-magnetic crystal grains 8 are easily formed. Moreover, in a case where the content of the element M is 0.67 mass % or more, a grain boundary phase with a low melting point is easily formed in the hot pressing step and the hot deforming step to be described later. Therefore, a hot pressing temperature and a hot deforming temperature can be set to be low, and the coercivity of the hot deformed magnet 2 easily increases. In a case where the content of the element M is 7.30 mass % or less, the formation of the plurality of non-magnetic crystal grains 8 is moderately suppressed, a ratio of the main phase grains 4 in the hot deformed magnet 2 increases, and the residual magnetic flux density of the hot deformed magnet 2 easily increases.

A content of Cu in the hot deformed magnet 2 may be from 0.01 mass % to 1.50 mass %, or from 0.04 mass % to 0.50 mass %. The content of Cu is within the above range so that the hot deformed magnet 2 is easily forged, and the coercivity, a corrosion resistance, and temperature characteristics of the hot deformed magnet 2 are easily improved. However, the hot deformed magnet 2 does not need to contain Cu.

A content of Ga in the hot deformed magnet 2 may be from 0.03 mass % to 1.00 mass %, or from 0.20 mass % to 0.80 mass %. In a case where the content of Ga is within the above range, generation of a subphase (for example, phase including R, T, and Ga) is moderately suppressed, and the residual magnetic flux density and the coercivity of the hot deformed magnet 2 easily increase. However, the hot deformed magnet 2 does not need to contain Ga.

The hot deformed magnet 2 may contain aluminum (Al). For example, a content of Al in the hot deformed magnet 2 may be from 0.01 mass % to 0.2 mass %, or from 0.04 mass % to 0.07 mass %. The content of Al is within the above range so that the coercivity and the corrosion resistance of the hot deformed magnet are easily improved. However, the hot deformed magnet 2 does not need to contain Al.

The hot deformed magnet 2 may contain cobalt (Co). For example, a content of Co in the hot deformed magnet 2 may be from 0.30 mass % to 6.00 mass %, or from 0.30 mass % to 4.00 mass %. Since the hot deformed magnet 2 contains Co, the Curie temperature of the hot deformed magnet 2 is easily improved. Furthermore, since the hot deformed magnet 2 contains Co, the corrosion resistance of the hot deformed magnet 2 is easily improved. However, the hot deformed magnet 2 does not need to contain Co.

The hot deformed magnet 2 may contain cerium (Ce). For example, a content of Ce in the hot deformed magnet 2 may be from 1.42 mass % to 14.17 mass %. However, the hot deformed magnet 2 does not need to contain Ce.

A balance after excluding the above-described elements from the hot deformed magnet 2 may be only Fe, or Fe and other elements. In order for the hot deformed magnet 2 to have sufficient magnetic characteristics, a total of contents of the elements other than Fe in the balance may be 5 mass % or less with respect to a total mass of the hot deformed magnet 2.

The hot deformed magnet 2 may contain at least one element selected from the group consisting of silicon (Si), titanium (Ti), manganese (Mn), zirconium (Zr), vanadium (V), niobium (Nb), molybdenum (Mo), hafnium (Hf), tantalum (Ta), tungsten (W), bismuth (Bi), tin (Sn), calcium (Ca), carbon (C), nitrogen (N), oxygen (O), chlorine (Cl), sulfur (S), and fluorine (F), as the other elements (for example, inevitable impurities). For example, a total of contents of the other elements in the hot deformed magnet 2 may be from 0.001 mass % to 0.50 mass %.

For example, the composition of the whole of the hot deformed magnet 2 may be analyzed by an X-ray fluorescence (XRF) analysis method, a high frequency inductively coupled plasma (ICP) atomic emission spectroscopy, an inert gas fusion-non dispersive infrared (NDIR) method, a combustion in an oxygen stream-infrared absorption method, an inert gas fusion-thermal conductivity method, or the like.

For example, the hot deformed magnet 2 may be applied to a motor, a generator, an actuator, or the like. For example, the hot deformed magnet 2 may be used in various fields such as a hybrid vehicle, an electric vehicle, a hard disk drive, a magnetic resonance imaging device (MRI), a smartphone, a digital camera, a flat TV, a scanner, an air conditioner, a heat pump, a refrigerator, a vacuum, a washer-dryer, an elevator, or a wind power generator.

### (Method for Manufacturing Hot Deformed Magnet)

A method for manufacturing the hot deformed magnet according to the present embodiment includes at least a ribbon preparation step, a hot pressing step, a hot deforming step, and an unloading step. The method for manufacturing the hot deformed magnet may further include another step such as a grain boundary diffusion step following the unloading step. However, the grain boundary diffusion step is not essential.

In order to suppress oxidation of the hot deformed magnet and its work in process in a manufacturing process, the method for manufacturing the hot deformed magnet may be performed under a non-oxidative atmosphere. For example, the non-oxidative atmosphere may be inert gas such as argon (Ar) gas. The non-oxidative atmosphere may further contain reducing gas such as hydrogen gas (H₂) in addition to the inert gas.

The ribbon preparation step is a step of preparing an alloy ribbon from a plurality of kinds of raw material metals by a rapid-solidification method. In the rapid-solidification method, molten metal in a crucible is ejected from a nozzle positioned at a front end of the crucible to the surface of the cooled roll. The molten metal comes into contact with the surface of the cooled roll, is instantly flicked by the cooled roll that rotates at high speed to form a large number of elongated ribbons. The molten metal is rapidly cooled and solidified by contact with the surface of the cooled roll. As a result, a large number of elongated alloy ribbons are formed. A container is installed in a direction in which the alloy ribbons are flicked by the cooled roll, and the alloy ribbons are collected into the container.

The molten metal is metal (plurality of kinds of raw material metals) containing a plurality of kinds of elements configuring the hot deformed magnet. The plurality of kinds of raw material metals may contain, for example, a simple substance of a rare-earth element (metal simple substance), an alloy including a rare-earth element, pure iron, ferroboron, or an alloy containing these. The plurality of kinds of raw material metals may contain the element M described above. The plurality of kinds of raw material metals are weighed so as to match a desired composition of the hot deformed magnet.

The molten metal may be obtained by heating the plurality of kinds of raw material metals in the crucible by high-frequency induction heating. A temperature of the molten metal ejected from the nozzle (ejection temperature) may be, for example, about 1400° C. A temperature rising rate until the temperature of the raw material metal reaches the ejection temperature may be, for example, about 20 to 100° C./sec.

The surface of the cooled roll may be composed of metal having a higher thermal conductivity such as Cu. The temperature of the surface of the cooled roll may be controlled by a refrigerant flowing in the cooled roll. For example, the temperature of the surface of the cooled roll may be controlled so that the cooling speed of the molten metal at the surface of the cooled roll becomes about 105 to 10⁶° C./sec. As the cooling speed is higher, a grain diameter of a crystal (R₂T₁₄B) contained in the alloy ribbon easily becomes finer, and the coercivity of the hot deformed magnet easily increases. As an amount of the molten metal ejected to the surface of the cooled roll in unit time is smaller, the molten metal attached to the surface of the cooled roll becomes thinner, the cooling speed increases, and the alloy ribbon becomes thinner. As a circumferential speed of the cooled roll is higher, the molten metal attached to the surface of the cooled roll becomes thinner, the cooling speed becomes higher, and the alloy ribbon becomes thinner. A thickness of the main phase grain (length of short axis of main phase grain) in the easy magnetization axis direction depends on a thickness of the alloy ribbon (and pulverization and classification of alloy ribbon). As the alloy ribbon is thinner, the thickness (grain diameter) of the main phase grain decreases, and the coercivity of the hot deformed magnet tends to increase. For example, the thickness of the alloy ribbon may be from 20 μm to 60 μm, or from 30 μm to 50 μm. For example, a width of the alloy ribbon may be from 1.0 mm to 5.0 mm.

After the ribbon preparation step, a pulverization/classification step may be performed. The pulverization/classification step is a step of pulverizing the alloy ribbon using a pulverization device to prepare coarse powders and classifying the coarse powders to collect alloy powders having a predetermined grain diameter and aspect ratio. The alloy powder is a precursor of the main phase grain contained in the hot deformed magnet. A shape of each alloy grain configuring the alloy powder may be a plate-like shape or a flake shape. A method for pulverizing the alloy ribbon may be, for example, at least one method of a cutter mill and a propeller mill. Means for classifying the coarse powder may be a sieve. A grain diameter and a grain distribution of the alloy powder obtained by the classification may be measured, for example, by a laser diffraction scattering method. The grain diameter of the alloy powder obtained by the classification may be, for example, from 60 μm to 2800 μm, or from 150 μm to 2800 μm.

The hot pressing step is a step of forming a compact by pressurizing the alloy ribbons (alloy powder) while heating the alloy ribbons. For example, the alloy powders may be compressed by a mold while heating the alloy powders in the mold. By pressurizing the alloy powders, air gaps between the alloy powders are reduced, and the dense compact is obtained. Furthermore, by heating the alloy powder with pressurization, a liquid phase (R-rich phase such as Nd-rich phase) is formed from the surface of the alloy powder, and the air gaps (grain boundaries) between the alloy powders are filled with the liquid phase. The alloy powder is lubricated by the liquid phase so that the alloy powder is easily compressed and the dense compact is easily obtained. A cold pressing step may be performed before the hot pressing step. In the cold pressing step, the compact may be formed by pressurizing the alloy powders at ordinary temperature (room temperature). By pressurizing the compact obtained by the cold pressing step while heating the compact in the hot pressing step, the compact may be densified. For example, a temperature (hot pressing temperature) of the alloy powder in the hot pressing step may be from 550° C. to 800° C. In a case where the hot pressing temperature is too low, a sufficient liquid phase is not formed from the surface of the alloy powder, and the compact is hardly densified. In a case where the hot pressing temperature is too high, grain growth of crystals (R₂T₁₄B) configuring the alloy powder excessively proceeds, and the coercivity of the hot deformed magnet is easily lowered. For example, a pressure (hot pressing pressure) applied to the alloy powder in the hot pressing step may be from 50 MPa to 200 MPa. For example, a time period (hot pressing time) in which the hot pressing temperature and the hot pressing pressure are maintained within the above range may be from several tens of seconds to several hundreds of seconds.

After the hot pressing step, the hot deforming step is performed. The hot deforming step is a step of obtaining a magnet base material containing the plurality of main phase grains (crystal grains of R₂T₁₄B), whose c-axes (easy magnetization axes) are oriented in a predetermined direction, by hot extrusion of the compact obtained in the hot pressing step. For example, in the hot deforming step, the compact is extruded from the mold while heating the compact. In the mold, grain boundary phases in the heated compact are liquefied and the liquid phases (R-rich phases) are generated, a stress acts on the compact in a predetermined direction, and each alloy grain configuring the compact is distorted. Accompanied by the generation of the liquid phases and the distortion of the alloy grains, anisotropic growth of the crystal grains in a direction perpendicular to the c-axis of the crystal grain proceeds. Furthermore, the liquid phase lubricates each crystal grain, and a force acts on each crystal grain according to the stress. As a result, the crystal grain rotates due to grain boundary sliding, and the c-axis of each crystal grain (main phase grain) is oriented substantially parallel to a stress direction. In other words, the plurality of platelet-shaped main phase grains extending in a direction substantially perpendicular to the c-axis are stacked along the stress direction.

For example, a temperature of the compact in the hot deforming step (hot deforming temperature) may be 700° C. or higher and lower than 900° C., or from 700° C. to 850° C.

In a case where the hot deforming temperature is too low, the liquid phase (R-rich phase such as Nd-rich phase) is hardly generated in the grain boundary in the compact, the crystal grain is hardly grown, and the rotation of the crystal grain due to the crystal grain sliding hardly occurs. As a result, an average value of the lengths of the short axes of the main phase grains easily becomes less than 20 nm, and the c-axis of each main phase grain (crystal grain) is hardly oriented substantially parallel to the stress direction.

In a case where the hot deforming temperature is too high (for example, a case where hot deforming temperature is 900° C. or higher), the liquid phase (R-rich phase) excessively exudes from each alloy grain, segregates to the surface of each alloy grain and the interface between alloy grains, and the most liquid phase is consumed for grain growth of the crystal grain. Most liquid phase is consumed for the grain growth of the crystal grain so that the grain growth of the main phase grain (crystal grain) abnormally proceeds, the coarse main phase grain is easily formed, and the average value of the lengths of the short axes of the main phase grains easily exceeds 200 nm. The coarse main phase grain is hardly oriented in the easy magnetization axis direction.

For example, an extrusion speed of the compact in the hot extrusion may be from 0.01 mm/sec to 9.9 mm/sec. In a case where the extrusion speed is too high (for example, in a case where extrusion speed is 10 mm/sec or higher), the anisotropic growth of the main phase grain (crystal grain) in the compact does not sufficiently proceed. Therefore, the average value of the lengths of the short axes of the main phase grains (primary grain) tends to be less than 20 nm. That is, in a case where the extrusion speed is too high, the compact is extruded from the mold before the anisotropic growth of the crystal grain in the compact sufficiently proceeds. As a result, the c-axis of each main phase grain (crystal grain) is hardly oriented to be parallel to the stress direction.

For example, a pressure applied to the compact in the hot deforming step (hot deforming pressure) may be from 35 MPa to 50 MPa. In a case where the hot deforming pressure exceeds 50 MPa, the plurality of crystal grains 8 are hardly formed, and the crystal zone axes cza of the plurality of crystal grains 8 are hardly oriented along the single direction (orientation direction D). For example, a time period (hot deforming time) in which the hot deforming temperature and the hot deforming pressure are maintained within the above range may be several tens of seconds.

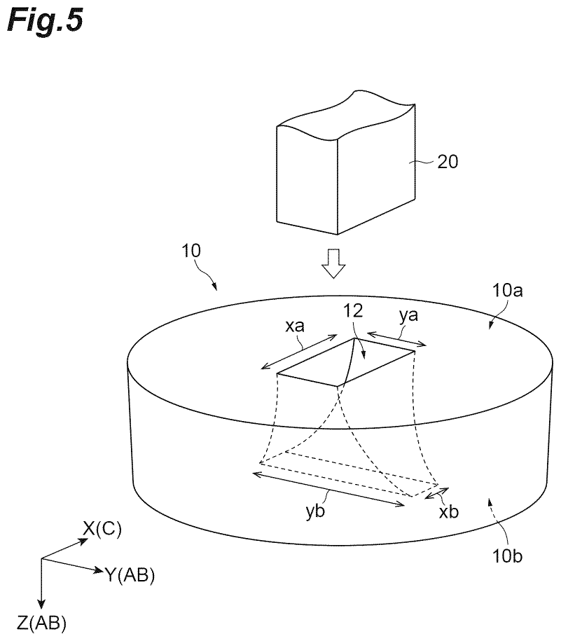

For example, as shown in FIG. 5, a shape of a mold 10 used in the hot deforming step is a cylinder. That is, the mold 10 has a pair of circular end surfaces (starting end surface 10a and ending end surface 10b) and a cylindrical side surface. A cavity 12 formed in the mold 10 penetrates the mold 10 from the starting end surface 10a toward the ending end surface 10b. That is, an inlet of the cavity 12 (inlet for compact 20) opens at the starting end surface 10a, and an outlet of the cavity 12 (extrusion port for compact 20) opens at the ending end surface 10b. The compact 20 is introduced into the inlet of the cavity 12 at the starting end surface 10a. Due to the hot pressing pressure applied to the compact 20 by an upper ram of a pressing machine, the compact 20 is extruded from the outlet of the cavity 12 at the ending end surface 10b. That is, a direction from the starting end surface 10a toward the ending end surface 10b is an extrusion direction Z of the compact 20, and a direction of the hot deforming pressure is equal to the extrusion direction Z. The starting end surface 10a and the ending end surface 10b are planes parallel to each other, and the extrusion direction Z is perpendicular to the starting end surface 10a and the ending end surface 10b.

A shape of the cavity 12 in a direction perpendicular to the extrusion direction Z (direction parallel to starting end surface 10a and ending end surface 10b) is a quadrilateral of which all of four angles are right angles. A pair of sides facing each other in this quadrilateral are referred to as first sides, and another pair of sides facing each other in the quadrilateral are referred to as second sides.

A length xa of the first side on the starting end surface 10a (inlet of cavity 12) is longer than a length ya of the second side on the starting end surface 10a (inlet of cavity 12).

The length xa of the first side gradually decreases along the extrusion direction Z and finally coincides with a length xb of the first side on the ending end surface 10b (outlet of cavity 12). That is, the length xb of the first side on the ending end surface 10b (outlet of cavity 12) is shorter than the length xa of the first side on the starting end surface 10a (inlet of cavity 12).

In contrast, the length ya of the second side gradually increases along the extrusion direction Z and finally coincides with a length yb of the second side on the ending end surface 10b (outlet of cavity 12). That is, the length yb of the second side on the ending end surface 10b (extrusion port of cavity 12) is longer than the length ya of the second side on the starting end surface 10a (inlet of cavity 12).

As a result of the decrease in the length xa of the first side along the extrusion direction Z and the increase in the length ya of the second side along the extrusion direction Z, the length xb of the first side at the outlet of the cavity 12 is shorter than the length yb of the second side at the outlet of the cavity 12. Moreover, due to a change in the length of each of the first side and the second side along the extrusion direction Z, an opening area of the cavity 12 in the direction perpendicular to the extrusion direction Z gradually decreases along the extrusion direction Z. That is, an opening area of the outlet of the cavity 12 on the ending end surface 10b is smaller than an opening area of the inlet of the cavity 12 on the starting end surface 10a.

Due to the changes in the shape and the opening area of the cavity 12 along the extrusion direction Z, a stress substantially or completely parallel to the first side of the cavity 12 acts on the compact 20 passing through the cavity 12. Due to the stress acting on the compact 20 by the cavity 12, the grain boundary sliding and the rotation of the main phase grain occur in the compact 20. As a result, the c-axis of the main phase grain is oriented along the stress direction (direction X of the first side). That is, the easy magnetization axis direction C of the magnet base material obtained by the hot extrusion substantially or completely coincides with the direction (direction X) of the first side on the ending end surface 10b.

The unloading step subsequent to the hot deforming step includes a first step and a second step subsequent to the first step.

In the first step, while pressurizing the magnet base material with a pressure p, the magnet base material is heated.

In the second step, natural cooling of the magnet base material is performed while pressurizing the magnet base material with the pressure p, and the pressure p applied to the magnet base material is released after natural cooling.

In both of the first step and the second step, the magnet base material is held between a pair of rams of a double-shaft pressing machine to be pressurized. The pressure p to be applied to the magnet base material is substantially or completely parallel to the easy magnetization axis direction C of the magnet base material. In the first step, a temperature of the pair of rams is maintained at a predetermined temperature (unloading temperature t), and the magnet base material is heated by the pair of rams.

The pressure p applied to the magnet base material in the unloading step may be from 35 MPa to 70 MPa, or from 35 MPa to 50 MPa. In a case where the pressure p exceeds 70 MPa, the plurality of crystal grains 8 are hardly formed, and the crystal zone axes cza of the plurality of crystal grains 8 are hardly oriented along the single direction (orientation direction D). In a case where the unloading step is not performed, the plurality of crystal grains 8 are hardly formed, and the crystal zone axes cza of the plurality of crystal grains 8 are hardly oriented along the single direction (orientation direction D). For example, the unloading temperature t may be from 25° C. to 500° C. A time period, in which the magnet base material is pressurized with the pressure p and the temperature of the magnet base material is maintained at the unloading temperature t, may be from 60 seconds to 600 seconds.

The magnet base material obtained by the above steps may be a finished product of the hot deformed magnet. A magnet base material subjected to the following grain boundary diffusion step may be a finished product of the hot deformed magnet.

After the unloading step, the grain boundary diffusion step described below may be performed. The grain boundary diffusion step is a step of attaching a diffusing material containing the heavy rare-earth element to the surface of the magnet base material and heating the diffusing material and the magnet base material. By heating the magnet base material to which the diffusing material is attached, the heavy rare-earth element in the diffusing material is diffused from the surface of the magnet base material to an inside of the magnet base material. In the magnet base material, the heavy rare-earth elements diffuse to the vicinity of the surfaces of the main phase grains via the grain boundaries. In the vicinity of the surfaces of the main phase grains, a part of light rare-earth elements (Nd or the like) are substituted with the heavy rare-earth elements. The heavy rare-earth elements are localized in the vicinity of the surfaces of the main phase grains and the grain boundaries so that the anisotropy field locally becomes larger in the vicinity of the grain boundaries and the nucleus of the magnetization reversal is hardly generated in the vicinity of the grain boundaries. As a result, the hot deformed magnet having a high coercivity is obtained.

For example, temperatures (diffusion temperature) of the diffusing material and the magnet base material in the grain boundary diffusion step may be from 550° C. to 900° C. For example, a time period (diffusion time) in which the diffusion temperature is maintained within the above range may be from 1 minute to 1440 minutes.

The diffusing material may contain at least one kind of heavy rare-earth elements of Tb and Dy. The diffusing material may further contain at least one kind of light rare-earth element of Nd and Pr, in addition to the heavy rare-earth element. The diffusing material may be, for example, metal consisting of one kind of the above elements, a hydride of the one kind of element, an alloy containing the plurality of kinds of elements, or a hydride of the alloy. The diffusing material may be powder. In the grain boundary diffusion step, the surface of the magnet base material may be coated with slurry containing the diffusing material and an organic solvent. In the grain boundary diffusion step, the surface of the magnet base material may be covered with a sheet including the diffusing material and a binder. In the grain boundary diffusion step, the surface of the magnet base material may be covered with an alloy foil (ribbon) composed of the diffusing material. The diffusing material does not need to contain the element M described above.

In order to promote the diffusion of the diffusing material, the surface of the magnet base material may be polished before the grain boundary diffusion step. In order to remove the diffusing material remaining on the surface of the magnet base material after the grain boundary diffusion step, the surface of the magnet base material may be polished after the grain boundary diffusion step.

A dimension and a shape of the magnet base material may be adjusted, for example, by cutting and polishing the magnet base material. A passive layer may be formed on the surface of the magnet base material, by oxidation or chemical treatment of the surface of the magnet base material. The surface of the magnet base material may be covered with a protective film such as a resin film. The passive layer or the protective layer improves the corrosion resistance of the hot deformed magnet.

The present disclosure is not necessarily limited to the above-described embodiment. Various modifications of the present disclosure are possible without departing from the gist of the present disclosure, and such modifications are also included in the present disclosure.

### EXAMPLES

The present disclosure will be described in detail by the following Examples and Comparative Examples. The present disclosure is not limited by the following Examples.

### <Preparation of Hot Deformed Magnet>

### Example 1

Each step in the following Example 1 was performed in the non-oxidative atmosphere (Ar gas).

In the ribbon preparation step, the alloy powder (alloy ribbon) was prepared from the molten metal containing the plurality of kinds of raw material metals, by the rapid-solidification method. The molten metal used in the ribbon preparation step contained Nd, Fe, Co, Ga, Cu, and B. Ga and Cu correspond to the element M described above. A content of each element in the molten metal of Example 1 was a value shown in the following table 1.

In the hot pressing step, the compact was prepared by compressing the alloy powder with the mold, while heating the alloy powder in the mold. The compact was a rectangular parallelepiped. Dimensions of the compact were 22 mm×11 mm×30 mm. The hot pressing temperature was 660° C. The hot pressing pressure was 100 MPa. The hot pressing time was 240 seconds.

The hot deforming step subsequent to the hot pressing step was performed. In the hot deforming step, the magnet base material was prepared by the hot extrusion of the compact using the above-described mold 10 (mold 10 shown in FIG. 5). An outline of the hot deforming step was as described in the above embodiment.

Both of the inlet of the cavity 12 of the mold 10 and the outlet of the cavity 12 of the mold 10 were rectangles.

The length xa of the first side of the inlet of the cavity 12 was 22.0 mm. The length ya of the second side of the inlet of the cavity 12 was 11.0 mm.

The length xb of the first side of the outlet of the cavity 12 was 5.5 mm. The length yb of the second side of the outlet of the cavity 12 was 30.0 mm.

A deforming rate (unit: %) in the hot deforming step is defined as {(xa−xb)/xa}×100. That is, the deforming rate was {(22.0−5.5)/22.0}×100, that is, 75%.

A temperature of the mold 10 in the hot deforming step was 750° C. The extrusion speed of the hot extrusion was 0.1 mm/sec. The hot deforming pressure (maximum pressure Pmax) was a value shown in the following table 1.

The unloading step subsequent to the hot deforming step was performed. An outline of the unloading step was as described in the above embodiment. The pressure p applied to the magnet base material in the unloading step was a value shown in the following table 1. The unloading temperature t was 480° C. A time period in which the magnet base material is pressurized with the pressure p and heated at the unloading temperature t was 300 seconds.

The grain boundary diffusion step using the diffusing material was not performed.

According to the above method, the hot deformed magnet of Example 1 was prepared.

### Examples 2 to 9 and Comparative Examples 1 to 3

A content of each element in the molten metal of each of Examples 2 to 9 and Comparative Examples 1 to 3 was a value shown in the following table 1. Only the molten metal of Example 4 contained Pr and Dy, in addition to Nd, Fe, Co, Ga, Cu, and B.

The maximum pressure Pmax in the hot deforming step of each of Examples 2 to 9 and Comparative Examples 1 to 3 was a value shown in the following table 1.

The pressure p in the unloading step of each of Examples 2 to 9 and Comparative Example 2 was a value shown in the following table 1. The unloading step of each of Comparative Examples 1 and 3 was not performed. That is, in Comparative Examples 1 and 3, after the hot deforming step, natural cooling of the magnet base material was performed without heating and pressurizing the magnet base material.

Except for the above matters, the hot deformed magnet of each of Examples 2 to 9 and Comparative Examples 1 to 3 was prepared in the same manner as in Example 1.

### <Analysis of Hot Deformed Magnet>

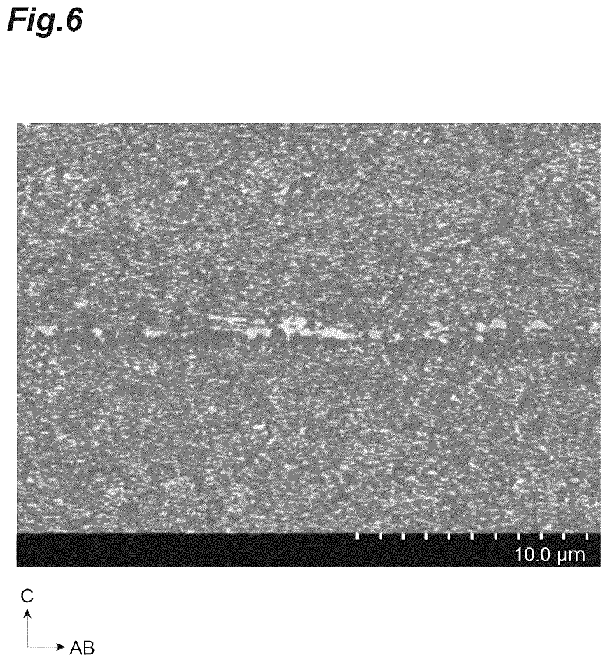

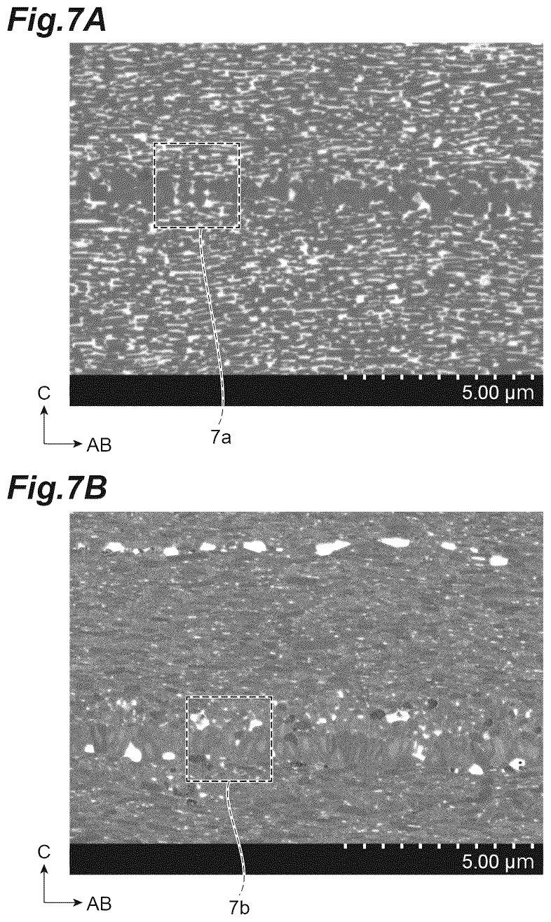

A backscattered electron image of the cross section of the hot deformed magnet of Example 1 was taken by the scanning electron microscope (SEM). Moreover, the composition of the cross section of the hot deformed magnet was analyzed by the energy dispersive X-ray spectroscopy device (SEM-EDS) equipped in the SEM. The cross section analyzed by the SEM and the SEM-EDS was parallel to the easy magnetization axis direction C of the hot deformed magnet. That is, the backscattered electron image of the cross section of the hot deformed magnet was parallel to the easy magnetization axis direction C. The plurality of backscattered electron images of Example 1 are shown in FIG. 6, FIG. 7A, and FIG. 7B.

The results of the analyses using the SEM indicated that the hot deformed magnet has the following features.

The composition of the hot deformed magnet coincided with a composition of the molten metal (composition shown in the following table 1).

The hot deformed magnet contained a large number of main phase grains (crystal grains of Nd₂T₁₄B).

The hot deformed magnet contained the grain boundary phase positioned between the plurality of main phase grains.

Each main phase grain contained at least Nd as R and contained at least Fe as T.

The large number of platelet-shaped main phase grains were observed in the cross section of the hot deformed magnet.

The short axis of the platelet-shaped main phase grain was substantially or completely parallel to the easy magnetization axis direction C.

The long axis of the platelet-shaped main phase grain was substantially or completely perpendicular to the easy magnetization axis direction C.

The large number of platelet-shaped main phase grains were stacked along the easy magnetization axis direction C.

As shown in a region 7a included in the backscattered electron image in FIG. 7A, the plurality of equiaxed crystals (main phase grains) were observed in the cross section of the hot deformed magnet. The plurality of equiaxed crystals were surrounded by the grain boundary phase. At least a part of equiaxed crystals were in contact with the crystal grains (crystal grains containing Nd and Cu) described later.

As shown in a region 7b included in the backscattered electron image in FIG. 7B, the plurality of columnar crystals (main phase grains) extending along the easy magnetization axis direction C were observed in the cross section of the hot deformed magnet. At least a part of the columnar crystals were in contact with crystal grains (crystal grains containing Nd and Cu) described later.

An average value of the widths S (lengths of short axes) of the plurality of main phase grains (primary grains) in the easy magnetization axis direction C was measured in the backscattered electron image of the cross section of the hot deformed magnet by the following method. A vertical width (width in easy magnetization axis direction C) of the backscattered electron image, where the average value of the widths S was measured, was 2.54 μm, and a horizontal width of the backscattered electron image, where the average value of the widths S was measured, was 1.90 μm. A plurality of representative positions in the backscattered electron image were selected, and a backscattered electron image of each position was taken at high magnification. The length of the short axis of each main phase grain (primary grain) existing in the backscattered electron image with the high magnification was measured. The shape of each main phase grain was approximated by a rectangle having a smallest area among rectangles circumscribing the main phase grain. A length of a long side of this rectangle was regarded as the length of the long axis of the main phase grain, and a length of a short side of the rectangle was regarded as the length of the short axis of the main phase grain.

The average value (unit: nm) of the widths S (lengths of short axes) of the plurality of main phase grains (primary grains) of Example 1 is shown in the following table 2.

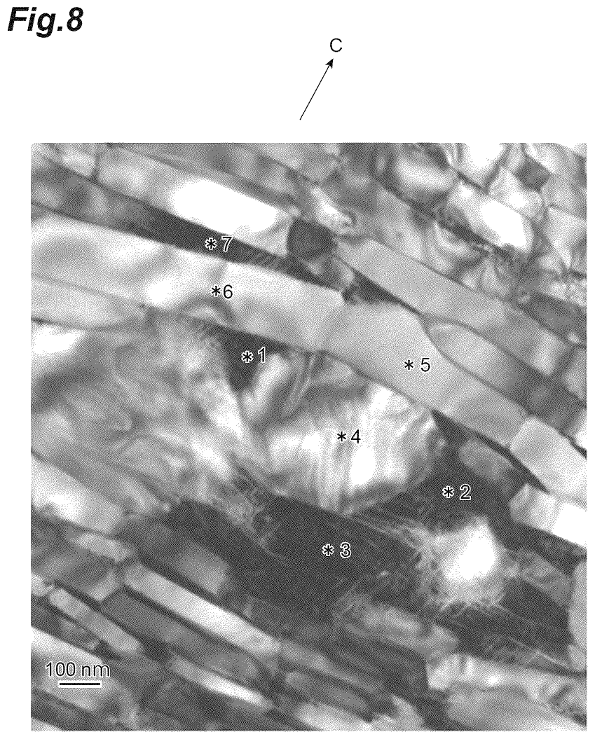

A TEM image of the cross section of the hot deformed magnet of Example 1 was taken by the transmission electron microscope (TEM). Moreover, the cross section of the hot deformed magnet (cross section where TEM image was taken) was further observed by the STEM, and a composition of the cross section was analyzed by the energy dispersive X-ray spectroscopy device (STEM-EDS) equipped in the STEM. The cross section analyzed by the TEM and the STEM-EDS was parallel to the easy magnetization axis direction C of the hot deformed magnet. That is, the TEM image of the cross section of the hot deformed magnet was parallel to the easy magnetization axis direction C. The TEM image of Example 1 is shown in FIG. 8.

A plurality of asterisks (*), to which numbers of 1 to 7 are attached, in FIG. 8 indicates positions of measurement points 1 to 7. A composition of each of the measurement points 1 to 7 was analyzed by the STEM-EDS. An electron beam diffraction pattern at each of the measurement points 1 to 7 was measured by the selected area electron diffraction (SAED).

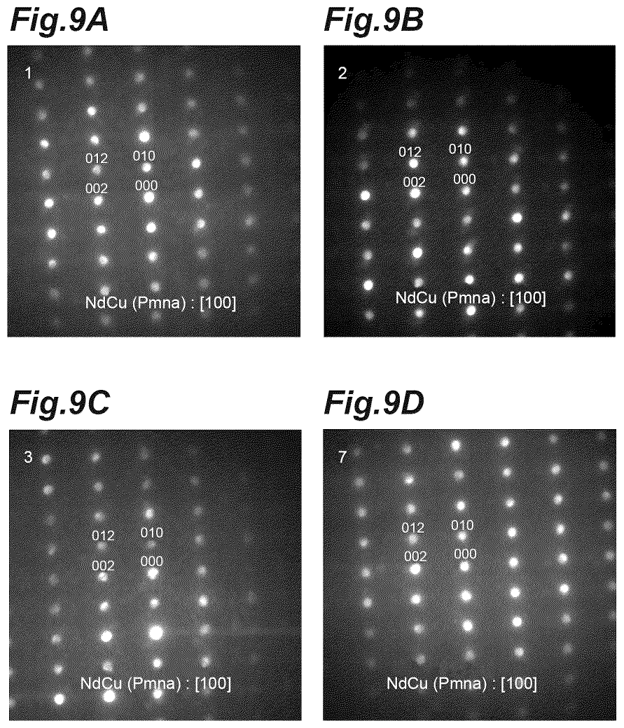

The electron beam diffraction pattern at the measurement point 1 is shown in FIG. 9A.

The electron beam diffraction pattern at the measurement point 2 is shown in FIG. 9B.

The electron beam diffraction pattern at the measurement point 3 is shown in FIG. 9C.

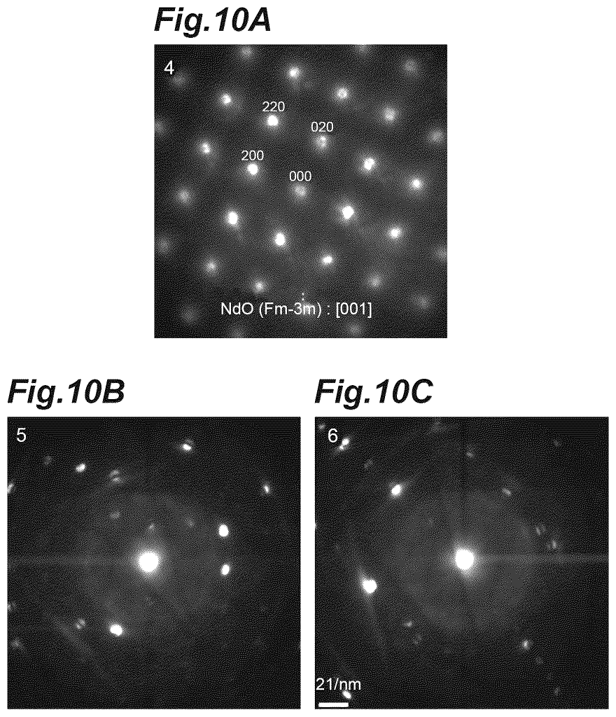

The electron beam diffraction pattern at the measurement point 4 is shown in FIG. 10A.

The electron beam diffraction pattern at the measurement point 5 is shown in FIG. 10B

The electron beam diffraction pattern at the measurement point 6 is shown in FIG. 10C

The electron beam diffraction pattern at the measurement point 7 is shown in FIG. 9D

Three numerical values written on each spot in each electron beam diffraction pattern indicate an orientation (Miller indices) of a lattice plane corresponding to each spot. The results of the analyses using the TEM and the STEM indicated that the hot deformed magnet has the following features.

A crystal grain containing Nd and Cu was detected at each of the measurement points 1 to 3 and 7. That is, the plurality of crystal grains containing Nd and Cu were detected. For example, a crystal grain represented by a chemical formula of Nd_{44.4}Cu_{44.0}Fe_{20.1}Co_{9.5} and a crystal grain represented by a chemical formula of Nd_{43.7}Cu_{44.3}Fe_{2.8}Co_{9.2} were detected. A unit of each numerical value in these chemical formulas is atom %.

NdO was detected at the measurement point 4.

The main phase grain was detected at each of the measurement points 5 and 6.

A concentration (unit: atom %) of Nd in each crystal grain containing Nd and Cu was higher than a concentration of Nd in each main phase grain.

Each crystal grain containing Nd and Cu was in contact with one or more main phase grains.

Each crystal grain containing Nd and Cu was a cubic crystal or an orthorhombic crystal.

A space group indicating symmetry of the crystal structure of each crystal grain containing Nd and Cu was Pnma.

The electron diffraction patterns of the measurement points 1 to 3 and 7 derived from the plurality of crystal grains containing Nd and Cu were compared with each other. The results of the comparison were as follows.

A crystal zone axes (<100>) of the plurality of crystal grains containing Nd and Cu were oriented along the single direction. That is, the crystal zone axes (<100>) of the plurality of crystal grains containing Nd and Cu were substantially or completely parallel to each other.

An angle between any pair of crystal zone axes among the crystal zone axes (<100>) of the plurality of crystal grains containing Nd and Cu was 3° at the maximum.

The (010) planes of the plurality of crystal grains containing Nd and Cu were oriented in the same direction. That is, the (010) planes of the plurality of crystal grains containing Nd and Cu were substantially or completely parallel to each other.

The area fraction AR of cross sections of the plurality of crystal grains containing Nd and Cu was measured using the backscattered electron image of the cross section of the hot deformed magnet. Details of a method for measuring the area fraction AR was as described in the above embodiment. A phase, that is positioned in the grain boundary phase, is in contact with the one or more main phase grains, contains Nd and Cu, and is clearly distinguished from the main phase grain and the other grain boundary phases in terms of contrast, was regarded as the crystal grain containing Nd and Cu. A vertical width (width in easy magnetization axis direction C) of the backscattered electron image, where the area fraction AR was measured, was 12.7 μm, and a horizontal width of the backscattered electron image, where the area fraction AR was measured, was 9.5 μm. For the measurement of the area fraction AR, ImageJ that is public-domain image processing software was used.

The area fraction AR (unit: %) of Example 1 is shown in the following table 2.

The electron beam diffraction pattern of each of the pair of the crystal grain and the main phase grain in contact with each other in the TEM image was measured. Based on these electron beam diffraction patterns, the angle θ between <001> of the crystal grain and <001> of the main phase grain was specified.

The angle θ (unit: °) of Example 1 is shown in the following table 2.

Five grain boundary phases containing the one or more crystal grains containing Nd and Cu were randomly selected from the TEM image of the cross section of the hot deformed magnet. The width W of each grain boundary phase was measured in the TEM image, and an average value of the widths W of the five grain boundary phases was calculated. The width W of the grain boundary phase is a width of the grain boundary phase in the easy magnetization axis direction C. A vertical width (width in easy magnetization axis direction C) of the backscattered electron image, where the width W of the grain boundary phase was measured, was 2.54 μm, and a horizontal width of the backscattered electron image, where the width W of the grain boundary phase was measured, was 1.90 μm.

The average value (unit: nm) of the widths W of the grain boundary phases of Example 1 is shown in the following table 2.

The coercivity (HcJ), the residual magnetic flux density (Br), and the squareness ratio (Hk/HcJ) of the hot deformed magnet of Example 1 were measured. The coercivity, the residual magnetic flux density, and the squareness ratio were measured by a BH tracer. The coercivity was measured at 23° C. The residual magnetic flux density was measured at room temperature. The squareness ratio was measured at 23° C. The coercivity (unit: kA/m), the residual magnetic flux density (unit: T), and the squareness ratio (unit: %) of Example 1 are shown in the following table 2.

The analyses and the measurements related to the hot deformed magnet of each of Examples 2 to 9 and Comparative Examples 1 to 3 were performed in the same manner as in Example 1. Results of the analyses and the measurements of each of Examples 2 to 9 and Comparative Examples 1 to 3 are shown in the following tables 2 and 3.

In each of Examples 1 and 5 to 7 and Comparative Example 1, a crystal grain A was detected as one of the plurality of crystal grains in contact with the one or more main phase grains.

In Example 2, a crystal grain B was detected as one of the plurality of crystal grains in contact with the one or more main phase grains.

In Example 3, a crystal grain C was detected as one of the plurality of crystal grains in contact with the one or more main phase grains.

In Example 4, a crystal grain D was detected as one of the plurality of crystal grains in contact with the one or more main phase grains.

In Comparative Example 2, a crystal grain E was detected as one of the plurality of crystal grains in contact with the one or more main phase grains.

In Example 8, a crystal grain F was detected as one of the plurality of crystal grains in contact with the one or more main phase grains.

In Comparative Example 3, a crystal grain G was detected as one of the plurality of crystal grains in contact with the one or more main phase grains.

In Example 9, a crystal grain H was detected as one of the plurality of crystal grains in contact with the one or more main phase grains.

The rare-earth element R, the transition metal element T, and the element M contained in each of the crystal grains A, B, C, D, E, F, G, and H are shown in the following table 3.

A content (unit: mass %) of each of R, T, and M in each of the crystal grains A, B, C, D, E, F, G, and H is shown in the following table 3.

A space group indicating symmetry of a crystal structure of each of the crystal grains A, B, C, D, E, F, G, and H is shown in the following table 3.

The crystal structure of each of the crystal grains A, B, C, D, E, F, G, and H is shown in the following table 3. “fcc” in the following table 3 means a face-centered cubic lattice structure (cubic crystal). “tet” in the following table 3 means a tetragonal crystal. “bcc” in the following table 3 means a body-centered cubic lattice structure (cubic crystal). “ort” in the following table 3 means an orthorhombic crystal.

“Oriented” described in the column of “Crystal zone axis” in the following table 2 means that an angle between any pair of crystal zone axes among the crystal zone axes (<100>) of the plurality of crystal grains containing Nd and Cu is 5° or less. That is, “Oriented” means that the crystal zone axes (<100>) of the plurality of crystal grains containing Nd and Cu are oriented in the single direction.

“Non-oriented” described in the column of “Crystal zone axis” in the following table 2 means that the angle between any pair of crystal zone axes among the crystal zone axes (<100>) of the plurality of crystal grains containing Nd and Cu is more than 5°. That is, “Non-oriented” means that the crystal zone axes (<100>) of the plurality of crystal grains containing Nd and Cu are not oriented in the single direction.

Except for the differences shown in the following table 2 and table 3, the hot deformed magnet of each of Examples 2 to 9 had the same features as those described in Example 1.

The hot deformed magnet of each of Comparative Examples 1 and 3 contained the plurality of crystal grains containing Nd and Cu. However, the crystal zone axes (<100>) of the plurality of crystal grains containing Nd and Cu were not oriented in the single direction in Comparative Examples 1 and 3. Except for this point, the hot deformed magnet of each of Comparative Examples 1 and 3 had the same features as those described in Example 1.

In the hot deformed magnet of Comparative Example 2, the plurality of crystal grains containing Nd and Cu were not detected. In a case of Comparative Example 2, a plurality of amorphous phases containing Nd and Cu were detected in the grain boundary phase. Except for these points, the hot deformed magnet of Comparative 2 had the same features as those described in Example 1. Only in Comparative Example 2, the average value of the widths W of the grain boundary phases means an average value of widths of grain boundary phases that do not contain the crystal grain containing Nd and Cu. In other words, only in Comparative Example 2, the average value of the widths W of the grain boundary phases means the average value of the widths of the grain boundary phases containing the amorphous phase containing Nd and Cu. Only in Comparative Example 2, the AR described in the following table 2 means an area fraction of cross sections of the plurality of amorphous phases, not the area fraction of the cross sections of the plurality of crystal grains.

Since the content of Nd in the raw material (alloy ribbon) of Comparative Example 2 is smaller than that of Example 1, a volume fraction of the Nd-rich phase in the compact formed from the alloy ribbon is lowered, and the grain boundary phase is hardly liquefied in the hot deforming step. Therefore, the formation of the grain boundary phase (liquid phase) in the hot deforming step becomes insufficient, and appropriate orientation of the main phase grain is hindered. As a result, the residual magnetic flux density is lowered. Since the grain boundary phase of Comparative Example 2 is an oxide of the Nd-rich phase, even if the magnet base material is cooled while maintaining a load (pressure p) in the unloading step after the hot deforming step, it is not possible to orient the crystal zone axes of the plurality of crystal grains in the grain boundary phase.

TABLE 1

| | Content of each element in molten metal (mass %) | | | | | | | | | Pmax | p |
|---|---|---|---|---|---|---|---|---|---|---|---|
| | Nd | Pr | Ce | Dy | Co | Ga | Cu | B | Fe | (MPa) | (MPa) |
| Example 1 | 28.05 | 0.00 | 0.00 | 0.00 | 5.09 | 0.55 | 0.40 | 1.02 | 64.89 | 50 | 50 |
| Comparative | 28.05 | 0.00 | 0.00 | 0.00 | 5.09 | 0.55 | 0.40 | 1.02 | 64.89 | 50 | — |
| Example 1 | | | | | | | | | | | |
| Example 2 | 29.03 | 0.00 | 0.00 | 0.00 | 5.03 | 0.54 | 0.56 | 0.89 | 63.95 | 40 | 40 |
| Example 3 | 31.17 | 0.00 | 0.00 | 0.00 | 3.96 | 0.59 | 0.66 | 0.83 | 62.79 | 35 | 35 |
| Comparative | 27.13 | 0.00 | 0.00 | 0.00 | 4.88 | 0.53 | 0.54 | 0.95 | 65.97 | 72 | 72 |
| Example 2 | | | | | | | | | | | |
| Example 4 | 10.65 | 17.40 | 0.00 | 2.07 | 3.40 | 0.50 | 0.07 | 0.97 | 64.94 | 45 | 45 |
| Example 5 | 28.05 | 0.00 | 0.00 | 0.00 | 5.09 | 0.55 | 0.40 | 1.02 | 64.89 | 50 | 55 |
| Example 6 | 28.05 | 0.00 | 0.00 | 0.00 | 5.09 | 0.55 | 0.40 | 1.02 | 64.89 | 50 | 60 |
| Example 7 | 28.05 | 0.00 | 0.00 | 0.00 | 5.09 | 0.55 | 0.40 | 1.02 | 64.89 | 50 | 70 |
| Example 8 | 27.60 | 0.00 | 1.42 | 0.00 | 5.03 | 0.53 | 0.56 | 0.89 | 63.97 | 40 | 40 |
| Comparative | 24.67 | 0.00 | 4.29 | 0.00 | 5.03 | 0.53 | 0.56 | 0.89 | 64.03 | 40 | — |
| Example 3 | | | | | | | | | | | |
| Example 9 | 14.58 | 0.00 | 14.17 | 0.00 | 5.05 | 0.54 | 0.57 | 0.89 | 64.20 | 40 | 45 |

TABLE 2

| | Crystal zone axis | AR | θ | W | S | HcJ | Br | Hk/HcJ | Crystal grain |
|---|---|---|---|---|---|---|---|---|---|
| | — | % | ° | nm | nm | kA/m | T | % | — |
| Example 1 | Oriented | 3.2 | 11.6 | 7.5 | 75 | 1313 | 1.46 | 98.2 | Crystal grain A |
| Comparative | Non-oriented | 3.5 | — | 7.2 | 70 | 1154 | 1.40 | 94.1 | Crystal grain A |
| Example 1 | | | | | | | | | |
| Example 2 | Oriented | 5.8 | 9.2 | 12.3 | 68 | 1512 | 1.35 | 96.6 | Crystal grain B |
| Example 3 | Oriented | 8.5 | 19.5 | 27.0 | 66 | 1342 | 1.25 | 90.5 | Crystal grain C |
| Comparative | — | 2.4 | — | 3.8 | 58 | 780 | 1.22 | 88.6 | Crystal grain E |
| Example 2 | | | | | | | | | |
| Example 4 | Oriented | 6.3 | 8.7 | 15.2 | 72 | 1591 | 1.33 | 96.2 | Crystal grain D |
| Example 5 | Oriented | 3.3 | 7.7 | 8.0 | 73 | 1392 | 1.43 | 98.1 | Crystal grain A |
| Example 6 | Oriented | 4.5 | 5.3 | 9.2 | 67 | 1426 | 1.44 | 98.5 | Crystal grain A |
| Example 7 | Oriented | 3.9 | 1.5 | 7.1 | 70 | 1455 | 1.47 | 98.3 | Crystal grain A |
| Example 8 | Oriented | 5.9 | 12.2 | 12.5 | 65 | 1477 | 1.32 | 95.5 | Crystal grain F |
| Comparative | Non-oriented | 6.6 | — | 12.2 | 67 | 1302 | 1.26 | 92.1 | Crystal grain G |
| Example 3 | | | | | | | | | |
| Example 9 | Oriented | 5.7 | 6.0 | 11.6 | 77 | 1345 | 1.27 | 92.7 | Crystal grain H |

TABLE 3

| | R | | T | | M | | | | |
|---|---|---|---|---|---|---|---|---|---|
| Crystal | | Content | | Content | | Content | | Space | Crystal |
| grain | Kind | mass % | Kind | mass % | Kind | mass % | Phase | group | structure |
| A | Nd | 64.68% | Fe, Co | 7.08% | Cu | 28.24% | Nd—Cu | Pnma | ort |
| B | Nd | 64.34% | Fe, Co | 6.91% | Cu | 28.75% | Nd—Cu | Pnma | ort |
| C | Nd | 53.40% | Fe, Co | 40.93% | Ga, Cu | 5.67% | Nd₆Fe₁₃Ga | I4/mcm | tet |
| D | Nd, Pr | 79.41% | Fe, Co | 15.60% | Ga | 4.99% | Nd-rich | Fm-3m | fcc |
| E | Nd | 96.27% | Fe, Co | 3.20% | Ga, Cu | 0.53% | Nd-rich | Ia-3 | bcc |
| F | Nd, Ce | 64.38% | Fe, Co | 6.28% | Cu | 29.34% | Nd—Cu | Pnma | ort |
| G | Nd, Ce | 64.28% | Fe, Co | 5.31% | Cu | 30.41% | Nd—Cu | Pnma | ort |
| H | Nd, Ce | 63.55% | Fe, Co | 4.91% | Cu | 31.54% | Nd—Cu | Pnma | ort |

### INDUSTRIAL APPLICABILITY

For example, an R-T-B based hot deformed magnet according to one aspect of the present disclosure may be applied to a material of a motor mounted on an electric vehicle or a hybrid vehicle.

### REFERENCE SIGNS LIST

2: Hot deformed magnet, 2cs: cross section of hot deformed magnet (cross section parallel to easy magnetization axis direction), 4: main phase grain, 6: grain boundary phase, 8: crystal grain (non-magnetic phase), C: easy magnetization axis direction, AB: direction perpendicular to easy magnetization axis direction, cza: crystal zone axis, D: single direction in which crystal zone axis is oriented.

What is claimed is:

1. A hot deformed magnet comprising: a rare-earth element R; a transition metal element T; and boron, wherein
the hot deformed magnet contains Nd, as the rare-earth element R,
the hot deformed magnet contains Fe, as the transition metal element T,
the hot deformed magnet contains a plurality of main phase grains and a grain boundary phase positioned between the plurality of main phase grains,
the plurality of main phase grains contain the rare-earth element R, the transition metal element T, and the boron,
the grain boundary phase contains a plurality of crystal grains,
the plurality of crystal grains are in contact with the one or more main phase grains, and
crystal zone axes of the plurality of crystal grains are oriented along a single direction.

2. The hot deformed magnet according to claim 1, wherein
the plurality of crystal grains are non-magnetic.

3. The hot deformed magnet according to claim 1, wherein
an area fraction of cross sections of the plurality of crystal grains in a cross section of the hot deformed magnet is from 3% to 8%, and
the cross section of the hot deformed magnet is parallel to an easy magnetization axis direction of the hot deformed magnet.

4. The hot deformed magnet according to claim 1, wherein
the plurality of crystal grains contain the rare-earth element R and an element M,
the element M is at least one selected from the group consisting of Cu, Ga, Zn, Ni, and Cr,
a content of the rare-earth element R in the plurality of crystal grains is from 50 mass % to 98 mass %,
a content of the transition metal element T in the plurality of crystal grains is from 0 mass % to 50 mass %, and
a content of the element M in the plurality of crystal grains is more than 0 mass % and 35 mass % or less.

5. The hot deformed magnet according to claim 1, wherein
each of the plurality of crystal grains is a cubic crystal, a tetragonal crystal, or an orthorhombic crystal, and
the crystal zone axes are <100>, <010>, or <001>.

6. The hot deformed magnet according to claim 1, wherein
the plurality of crystal grains contain Nd and Cu,
each of the plurality of crystal grains is a cubic crystal, a tetragonal crystal, or an orthorhombic crystal, and
a space group indicating symmetry of a crystal structure of each of the plurality of crystal grains is Pnma, I4/mcm, Fm-3m, or Ia-3.

7. The hot deformed magnet according to claim 1, wherein
a width of the grain boundary phase containing the one or more crystal grains is from 4 nm to 500 nm in an easy magnetization axis direction of the hot deformed magnet.

8. The hot deformed magnet according to claim 1, wherein
the one or more main phase grains in contact with the one or more crystal grains contain at least one of a columnar crystal and an equiaxed crystal.

9. The hot deformed magnet according to claim 1, further comprising: an element M, wherein
the element M is at least one selected from the group consisting of Cu, Ga, Zn, Ni, and Cr,
a content of the rare-earth element R in the hot deformed magnet is from 26.00 mass % to 32.00 mass %,
a content of the boron in the hot deformed magnet is from 0.77 mass % to 1.15 mass %, and
a content of the element M in the hot deformed magnet is from 0.67 mass % to 7.30 mass %.

10. The hot deformed magnet according to claim 1, wherein
a width of each of the plurality of main phase grains in an easy magnetization axis direction of the hot deformed magnet is represented as S,
a width of each of the plurality of main phase grains in a direction perpendicular to the easy magnetization axis direction is represented as L,
the S is smaller than the L,
L/S is from 2 to 10, and
the S is from 20 nm to 200 nm.

11. The hot deformed magnet according to claim 1, wherein
an angle between <100> of the plurality of crystal grains and <100> of the one or more main phase grains is from 0° to 10°.

12. The hot deformed magnet according to claim 1, wherein
an angle between <010> of the plurality of crystal grains and <010> of the one or more main phase grains is from 0° to 10°.

13. The hot deformed magnet according to claim 1, wherein
an angle between <001> of the plurality of crystal grains and <001> of the one or more main phase grains is from 0° to 10°.

14. The hot deformed magnet according to claim 1, wherein
the single direction in which the crystal zone axes of the plurality of crystal grains are oriented is parallel to crystal zone axes of the one or more main phase grains in contact with the plurality of crystal grains.
